(19) United States
(12) Patent Application Publication
(10) Pub. No.: US 2006/0031246 A1
(43) Pub. Date: Feb. 9, 2006

(54) Universal database method and system

(76) Inventor: Loren P. Grayson, (US)

Correspondence Address: KELLY LOWRY & KELLEY, LLP, 6320 CANOGA AVENUE, SUITE 1650, WOODLAND HILLS, CA, 91367, US

(21) Appl. No.: 11/190,150

(22) Filed: Jul. 25, 2005

Related U.S. Application Data
(60) Provisional application No. 60/599,191, filed on Aug. 4, 2004.

(51) Int. Cl. G06F 7/00

(52) U.S. Cl. 707/102

(57) ABSTRACT

A reusable, data-driven universal database model and system for modeling and storing data in all relationships in a form that supports any data to be added to the database. The database system can be implemented to any type of application storing any type of data or data drives in that relationship. The system includes a plurality of nodes having a many-to-many relationship by virtue of being connected with each and every node, and itself. Preferably, the database system is an unchanging format, enabling it to be used in software or embedded in a hardware form.

### RELATED APPLICATION

This application claims priority to U.S. Provisional Patent Application No. 60/599,191, filed Aug. 4, 2004.

### BACKGROUND OF THE INVENTION

The present invention generally relates to databases and data storage technologies. More particularly, the present invention relates to a universal database system which is designed to represent anything in the physical or virtual universe without the need to modify the database itself.

A database is a collection of organized information which a computer or other machine can use to store and retrieve data in an organized way. Databases generally use a regular structure to store, organize, and retrieve data in an organized way. A database is usually, but not necessarily, stored in some machine readable format accessed by a computer or other machine method.

Certainly databases are well-known and commonly used. In fact they are in common with all business activities as any business has information which needs to be stored and retrieved—from customer lists to accounting data.

The most useful way of classifying databases is by the programming model associated with the database. Several models have been in use for some time. Most databases resembling modern versions were first developed in the 1950s. There are a wide variety of databases in existence, from simple storage in a single file, to very large databases with many millions of records, stored in a room full of disk drives.

Flat File

Certainly the first database ever created was mostly likely just a list of text data used for lookup by systems such as the ENIAC or other early computer system. This type of data storage is called a “Flat File” and is what one might do if they were typing a shopping list in a text document—it was a simple list of data with very few items per row. Although this is very effective in simple circumstances, as more data accumulated it became increasingly difficult to locate something of interest. Worse, at that time storage was at a premium where even 8K or 16K was considered a lot of space, so everything had to be made as efficiently packed as possible, and long lists usually contain repeated information (such as a list of people in a city all having the same city and state information).

Even in those early years it became necessary to optimize data storage where certain records of data contained repeated data.

Even still, a Flat File database model wasn't an efficient storage method which was the impetus for the next model.

Hierarchical Model

The separation of data into what became known as “tables” of data with the individual line of represented data being called a “record”. Tables would contain data collected by some commonality and structure. And these tables would be tied together usually by one or more numeric values in common between records of different tables. This was the first concept of what became Normalization, which is the optimization of such databases by the classification and separation of repeated information.

The Hierarchical model allows multiple tables to be used together through the use of pointers or references branching out to lower associated data. This type of structure is still used for computer directory structures. It was a system of “parent” and “child” relationships in a fixed hierarchy. It was a very rigid design.

The problems arise when child records could be applied to multiple parents which resulted in repeated child data—as this model did not support multiple links “back” to a parent (towards the root) but only multiple links down towards the child records (away from the root). It had issues like one couldn't add a child record until one had a parent to attach it too, or if you deleted the parent all child records were also removed. Also, if one wanted to find a record in the middle of the hierarchy, one had to start at the top.

And also, branches never attached to a child record already “owned” by another parent. For instance, a branch going from a College Department down to two Courses and down to the Students in each course might find that some students would take more than one course in a department and thus have more than one record in this model (one linked to each course), wasting space by repeating data, mainly due to it's inability to support a Many-to-Many relationship.

Network Model

The Network model was an improvement to the Hierarchical model in that it added cross-indexed data and it was very efficient in storage (relative to the previous model). The best examples are airline booking systems.

It allowed complex data structures to be built but were inflexible and required careful design and could only be understood if you understood the “mind” of the programmer who organized the index as to the basic design. And it had many of the same limitations of the Hierarchical model.

Relational Model

Eventually the evolution of the Relational database model solved many of these problems. It consists of data tables linked to each other by references assigned by the database designer. With this, a database could be linked in any way that a database designer might choose to come up with—limited only by his imagination or logic. The Relational database model allowed the user to design links which didn't have to be anticipated by the creator of the database engine. And it was sufficiently superior over the previous methods that it has become the standard over several decades. Relational database have become very popular with business and other applications.

Using the Relational model, one might theoretically be able to apply Normalization (called “Normal Forms”) up to the 12^{th} Normal Form however rarely does anyone ever go beyond the 5^{th}—and most only use up to the 3^{rd} Normal Form. Under Normalization theory one might be able to completely abstract data into completely generic packages. The problem was no one ever determined what those packages might be—which is probably why people rarely apply the upper-level normalization to their databases.

The primary problem with the Relational model is that there was no single solution for everything. All developers essentially create their new and unique solutions for their immediate needs—which frequently resulted in future issues (as no one has ever sufficiently thought out a design which could support unknown future issues). And also, with every database essentially being unique, data portability was at a minimum, requiring many millions of hours and billions in funds annually just in the course of everyday data sharing.

Object Model

Some people have considered that these issues might be solved by a new model called the “Object Model”. This model attempts to create linkable “objects” to common elements using Object Oriented technology derived from programming languages. In theory, it supports data encapsulation, inheritance, polymorphism and other Object Oriented techniques. A grand idea, however, as yet, no one has ever solved what those common objects might be nor how they might be associated.

Database Dimensions

Even while reviewing each prior models, one sees a pattern. The Flat File database model or any which concentrate all data around a single table could be considered a “One Dimensional” database—including any database model which relies on one primary table (regardless of now many lesser dependent tables) including key word search engines (like Google™) to seemingly more complicated systems. One can typically analyze the complexity of the design using the number of key dimensions.

As databases grew more advanced on into Relational databases, the number of tables increased but usually there were always one or two primary tables about which everything else was linked. The more complex database designs utilize not one central table, but contain two or more data tables to which all others are linked. As simple as this might sound, even today's most complex systems never seem to go beyond this structure, even some seemly “complex” systems can ultimately be boiled down to two primary tables—which could be considered or called a “Two Dimensional” database. This type is very common in general and could represent the vast majority of all databases in use today.

There are, however, even more complex systems (although these are represented less in normal use). These are “Three Dimensional” designs where there are a grouping of three primary tables of similar importance with any number of lesser tables linked to these. An example might include a business system which centered around customers, products and accounts where these three primary tables were surrounded by lesser support tables. Oddly fewer company databases use this design and those that do, design the database to be specific to one task rather than making it universal.

Each of the prior art had concepts which were considered advances beyond the previous systems, however none of the prior art databases are universal databases, i.e., databases which could represent anything in the physical universe and all their associations by data alone—using the same core data structures. Accordingly, there is a continuing need for a universal database which is designed in such a way that database structure would never need to be changed, just the data itself, such that any possible data associations could be shown by data changes itself without changes to the database structure. The present invention fulfills these needs and provides other related advantages.

### SUMMARY OF THE INVENTION

The present invention resides in a universal database model and system, which is a reusable, data-driven resource for modeling and storing data and all relationship in the form that supports any data representing either the physical or any virtual universe. The present invention uses a standard, unchanging format, capable of storing any type of data, and can be implemented for any type of application storing any type of data for data drives the relationship.

If one were to consider the human mind as the ultimate computer containing the ultimate database model, one would notice that it stores certain types of information (the perceptions) as well as their analysis in an infinite number of combinations.

The ultimate problem was to figure out how one could create a better representation of the mind than any currently envisioned. And certainly one wasn't required to rebuild basic structures (e.g. the brain or other mechanisms of the mind) simply because of a new idea which didn't fit the previous “mold”. There was a standard form of data and it was this investigation which contributed to the results of this invention.

The most important item of any model which purports to be “universal” is the identification of the actual “universal” elements. This has been the primary weakness of all prior efforts. If one had the common data elements one might theoretically be able to build anything from them just as we build any type of molecule from a finite number of atom types. These common data elements have been identified and defined in this invention.

A method for creating a database system embodying the present invention generally comprises the steps of establishing a plurality of data-storing nodes, each node representing a different specific characteristic containing user-defined data. The plurality of nodes represent common denominator characteristics of all data to be added to the database system. Preferably, the plurality of nodes comprise of at least six nodes. Such six nodes are assigned user-defined data for the specific characteristics of: Be, Do, Have, Space, Energy and Time. In a particularly preferred embodiment, the plurality of nodes comprise eight nodes, with additional two nodes being assigned user-defined data with the specific characteristics of: Quanta, and Modifier.

A many-to-many relationship is created between the nodes by connecting each node to every other node and to itself. This is typically done by using link nodes having assigned identifications and data relating to the two nodes the link nodes connect. Moreover, a node and a link node may be connected with a link link node, which is also assigned identifications and data relating to the node and link node which they connect.

Each datum to be added to the database system is classified according to the specific node characteristics, and using user-assigned characteristics of each datum. Each datum is stored in the node representing the corresponding characteristic.

Relationships between data of two nodes are defined. These relationships are typically defined as similarities, differences, and identities.

Typically, the database of the present invention is established within a computer system having a main memory, a program processor, and a non-volatile storage medium having at least the six data-storing nodes. The program processor is used to define the relationship between the data contained in the connected nodes and serves as a database engine. Because the database of the present invention is preferably a standard and unchanging system and model, it is possible to incorporate the invention into hardware form. This can be embedded into semi-conductor and other electronic formats.

Other features and advantages of the present invention will become apparent from the following more detailed description, taken in conjunction with the accompanying drawings, which illustrate, by way of example, the principles of the invention.

### BRIEF DESCRIPTON OF THE DRAWINGS

The accompanying drawings illustrate the invention. In such drawings:

FIG. 1 is a schematic diagram illustrating the primary nodes of the database of the present invention;

FIG. 2 is a schematic diagram of the primary database nodes and simple links in accordance with the present invention;

FIG. 3A is a schematic diagram illustrating the logical and physical node-to-node links in accordance with the present invention;

FIG. 3B is a schematic diagram illustrating the logical and physical node-to-link-node connections in accordance with the present invention;

FIGS. 4A and 4B are schematic diagrams representing the two type of core connections necessary to link anything in accordance with the present invention;

FIG. 5 is a schematic diagram illustrating primary nodes and their links for Flows 0, 1, and 2 in accordance with the present invention;

FIG. 6 is a schematic diagram represent all the node-to-link-node connections for a single node in accordance with the present invention;

FIGS. 7A-7D are schematic views representing logical and physical views of each of the four flows of nodes linked to themselves or other nodes/link nodes;

FIGS. 8A-8D are schematic diagrams illustrating the primary nodes and their links for Flow 3 in accordance with the present invention.

FIG. 9 is a schematic diagram illustrating the 8-element database of the present invention;

FIG. 10 is a schematic diagram of the 8-element database nodes and simple links in accordance with the present invention;

FIG. 11 is a schematic diagram illustrating the 8-element database and their links for flows 0, 1, and 2 in accordance with the present invention;

FIGS. 12A-12E are schematic diagrams illustrating the 8-element database nodes and their links for flow 3 in accordance with the present invention;

FIGS. 13A-13D are schematic diagrams illustrating the capabilities of quanta to describe data in terms of constants, variables, or even equations and functions which could be created using the present invention;

FIG. 14 is a schematic diagram of several types of linked lists created using the Database of the present invention;

FIG. 15 is a schematic diagram of a queue data structure created using the present invention;

FIG. 16 is a schematic diagram of a stack data structure created using the present invention;

FIG. 17 is a schematic diagram of a B-Tree data structure created using the present invention;

FIG. 18 is a schematic diagram of a random tree data structure created using the present invention;

FIG. 19 is a schematic diagram of a heap data structure created using the present invention;

FIG. 20 is a schematic diagram of a Ring data structure created using the present invention;

FIGS. 21A and 21B are schematic diagrams of an incorrect and correct genealogy data structure created using the present invention;

FIG. 22A is a schematic diagram illustrating the proper form and structure for a person using the present invention;

FIG. 22B is a schematic diagram illustrating the relationship of people to common identities (such as names) using the present invention;

FIG. 23 is a diagram illustrating how individuals can be linked by a common identity using the present invention;

FIG. 24 is a schematic diagram illustrating how action steps can be linked using the present invention.

FIG. 25 is a schematic diagram illustrating how a Doingness such as the Olympics can be linked using the present invention;

FIG. 26 is a schematic diagram illustrating the correct relationships of an employee to a company using the present invention;

FIG. 27 is a schematic diagram illustrating a simple warehouse inventory structure which could be created using the present invention;

FIG. 28 is, a schematic diagram illustrating a simple paperless office system which could be created using the present invention;

FIG. 29 is a schematic diagram illustrating how the location of warehouse items are simplified throughout a typical packaging and delivery cycle using the present invention;

FIGS. 30A and 30B are schematic diagrams illustrating simple energy flows (explosions and implosions) using the present invention;

FIGS. 31A and 31B are schematic diagrams illustrating simple energy flows using the present invention;

FIG. 31C is a schematic diagram illustrating a simple energy flow in terms of accounting and funds transfers which could be created using the present invention;

FIG. 32 is a schematic diagram illustrating some simple business data structures which could be created using the present invention;

FIG. 33 is a schematic diagram illustrating a purchase order and an order data structure which could be created using the present invention;

FIG. 34 is a schematic diagram illustrating the automation capabilities as applied to rocketry guidance programming which could be created using the present invention;

FIG. 35 is a schematic diagram illustrating the use of modifiers to describe automobile data which could be created using the present invention;

FIG. 36 is a schematic diagram illustrating a method of grammar and sentence parsing which could be created using present invention;

FIG. 37A is a schematic diagram illustrating a simple dictionary structure which could be created using the present invention;

FIG. 37B is a schematic diagram illustrating simple word relationships which could be created using the present invention;

FIG. 38 is a schematic diagram illustrating the application of invention to security;

FIG. 39 are schematic diagrams illustrating change log in the 6-element version and 8-element version, in accordance with the present application; and

FIG. 40 is a schematic diagram illustrating the application of this invention to networks and networking;

### DEFINITIONS

Database

A collection of organized information which can be used to store and retrieve data in an organized way, typically utilized by a computer or computerized system.

Logical Representation

By a Logical Representation (or View), we're referring to a conceptual view of a model as opposed to a physical or structural view. In the Logical view we're more concerned with the relationships of data and the data itself rather than the technical implementation behind those relationships or the data.

Physical Representation

By a Physical Representation (or View), we're referring to a lower-level view than the Logical Representation, however we do not go so far as to define the exact layouts of structures such as Tables, Records, Fields, or Datatypes of any database object. This is a somewhat abstracted representation with implications regarding structure but allowing flexible implementations.

Structural Representation

By a Structural Representation (or View), we're referring to the lowest-level view and all aspects necessary to the construction of a database. Here, we're referring to the exact layout of any database structures such as tables, records, fields and datatype definitions.

Element

An Element is one of the primary logical atoms of the database. It contains all the data and attributes of any datum being stored. When referenced in this document, we're referring primarily to a logical viewpoint of these atoms. They come in one of eight forms:

1. Be, Beingness (B)—A state or condition of an identity (or being identified) or an assumption of a category of identity. It is an identification or any way something is identified (person or thing). Beingness could include any or all ways something is identified.

2. Do, Doingness (D)—By doing, we mean action, function, accomplishment, the attainment of goals, the fulfilling of purpose, or any change of position in space. Doing is the action of creating an effect. Doingness is the condition of the creation of an effect. Doingness could include any or all activities.

3. Have, Havingness (H)—To have something is to be able to touch or permeate or to direct the disposition of it. Havingness could be considered to be an ability to communicate with the environment. It is the concept of being able to reach or not being prevented from reaching something. The feeling that one owns or possesses something. Havingness could include any and all things which one could have, control or perceive.

4. Space (S)—is the viewpoint of dimension. It is a point, line, area, volume in physical terms or location in logical terms.

5. Energy (E)—is the potential or kinetic motion or power as a flow, dispersal or ridge. It could include any and all forces, efforts or direction motions.

6. Time (T)—An abstract manifestation and consideration of mechanically tracked alteration of position of particles (including energy). It includes any reference to time (in part or in whole).

7. Quanta (Q)—is defined as the abstract entity of numbers, math and equations. A conceptual, numeric representation of the universe. It is the worlds of symbols and mathematics.

8. Modifier (M)—In the English language this would be considered an adjective for any noun or an adverb for any verb.

When referenced in this document, we're referring only to the logical viewpoint of these atoms. The first six elements are the Core or Primary Elements which is why this design is sometimes referred to as the BDH-SET expressed as either 6- or 8-elements while BDH-SET+QM implicitly states an 8-element system.

Node

A Node is a physical representation of the elements. The difference between a Node and an Element is that when we're referring to an Element we're talking more about how the data is used while the node shows a more lower-level view of the database design. In a logical relationship (the Element) we're not interested which tables link two tables but simply the fact that they are linked. In a physical relationship, we're more interested in some of the linking and dynamic table structures. Below this is the structural definition of the database tables. It should be stated that this document does not define the field-by-field layout of any tables other than that they conform to the requirements herein. All time data is stored in the Time Node, this document simply defines what they should do. How it is implemented and any necessary fields are up to the implementation.

Table

A Table is a structural item. In a database it is the two-dimensional container of data records. Normally tables are organized to contain closely linked data which are referred to as “Records”.

Record

A Record is a structural item. It is one dimension of a table's data which contains specific data about an item of which the table represents. Sometimes also referred to as a “Row”. A Record usually contains several Fields which are attributes of this one common data.

Field

A Field is a structural item. It is one datum from a record. In a database, tables are composed of records, and records are composed of Fields. These fields contain the same type of data for the same field from one record to the next.

Datatype

A Datatype (as in “Data Type”) is the stored datum's form. From a structural viewpoint this might be types such as Integers, Character, Strings, Floating Point, Dates, etc. However, within this document we're referring to the Logical Representation of such data, where data may be of a defined logical type having nothing to do with the structure. Such datatypes might include “person”, “name”, “company”, “city”, or even numbers such as “33”—where we're not concerned what structural type it is but that it represents a usable value.

Link

A Link is the logical viewpoint of the association of any two elements without concern to the physical mechanics. It is to an Element what a Link Node is to a Node. The details of a Link Node are further described within this document.

Link Node

A Link Node is the physical viewpoint of the association of any two nodes. This is more an issue of the mechanics of such a connection between those tables in order to create a Many-to-Many relationship. Although there are many ways to create Many-to-Many relationships, these are most commonly managed at a structural representation by a table between the two node tables. For this document, we're not concerned with the structural implementation of this Link Node other than that is support our requirements of a Many-to-Many relationship, and any other logical requirement.

Link-Link Node

This is an association of a Node to a Link Node. Just as we have a Link Node which defines an association between two Nodes, so too are there conditions where a Node might be associated with a Link Node itself-connected by a Link-Link Node.

Molecule

Considering we're using terms such as Elements for logical representations of storage containers, and as we shall see that these containers may be associated in any number of combinations, these combinations are referred to as “Molecules” in this document.

### DETAILED DESCRIPTION OF THE PREFERRED EMBODIMENTS

The present invention, as shown in the accompanying drawings for the purpose of illustration and described more fully herein, is related to a universal database system and related model. The database of the present invention is designed in such a way that the database structure never need to be changes, just the data itself. The data defines the relationships and possible associations are shown by data changes itself, without changes to the database structure.

The database of the present invention is capable of representing any possible data in the physical universe as well as any possible relationship and logic. Any missing datum or relationship can be included at any time without affecting existing data. And a datum itself is never repeated in the database as it is accessible from any source.

The Elements (BDH-SET)

While all other technologies have been working with various tables all of unique types and contents, the primary issues have been the identification and classification of data into its common denominators. For only then could data be properly and adequately stored in a usable and re-usable form. The database as described in this document satisfies these conditions and more.

The first task involves the identification and isolation of these common elements. The original common elements are Beingness, Doingness and Havingness with each element linked to every other—including itself. Further, it was determined that Beingness was associated with Space, Doingness with Energy, and Havingness with Time. Lots of Space is always associated with a big Beingness. Lots of Energy is always associated with Activities (Doingnesses). Time is always associated with Objects (Havingnesses). So the links were expanded to include these six—interconnected each with every other. For convenience, this database model may be identified with the first letters of each primary element in the two triplets, known here as the “BDH-SET”.

Beingness Beingness is perhaps the most useful of all the nodes—or at least the most used. Virtually everything is identified in so many ways. A person by his name, Social Security Number, Driver's License Number, phone number, email address, finger prints, etc. An object might be identified by it's Item Name, the Bar Code, the Box Number, computer record number, etc. In fact, this is the most redundant area of all.

Naturally, the storage of this type of data requires a free-form container such as a string or another polymorphic interface. This includes the fact that all identities are invented which means that the data type of each Beingness should be user-defined too. While there are various ways of doing this, one of them could be to use strings for the value and another for the data type.

By far, this is the most significant of the Elements as there are so many ways to identify anything—even using different languages. And the relationships of these Beingnesses are staggering.

Some of these relationships are better represented in the Application section of this document as it requires an understanding of some of the other components necessary to this database system.

Doingness A Doingness generally has many doingnesses with it. One action can require many steps to complete. So Doingness is another hierarchy to climb just as a Genealogy tree would be for Beingness. A step might be a single instruction on how to build something on up to defining a group of steps as a whole task such as “Rebuilding Motor”.

Just as the Beingness could be built any number of ways by any number of standards, languages, or any type of system, again one of the simplest ways to store this type of data could be a string for the value and another for the user-definable data type.

Havingness Havingness, is the interface to the world. In some form or another, data being stored is stored here. While a document might have a Name (Beingness) or Doc ID (Beingness), this is the actual document file itself—or at least a pointer to it. This structure should be flexible enough to support any type of reference.

Technically, this also represents access to the outside universe much as the senses such as sight or sounds are how a human being access the universe. It is also the control interface such as commands to move something in the real universe.

This might be descriptions, things such as file names, or even commands to execute some real universe activity (as in the case of robotics). Of course this also means that the type must be defined by the user as according to what is being interfaced.

Through the modification of data in this interface (such as data in a file), one can interact with the outside universe including inflowing data. It is essentially an input/output buffer to the universe in terms of ownership or interaction.

With the above considerations, most I/O is in terms of passed data. Even computer processors use values to define how they manipulate blocks of data. It is standard in computer technology to pass data to and from hardware in terms of commands and data each defined in it's own buffer. SCSI protocols include a command buffer and a data buffer each being filled out with data and sent for processing as simply a reference address to those buffers. Whereupon the SCSI controller will look up the command buffer and read the data to determine what to do with data in the data buffer. This is standard procedure in computer technology.

The same could be implemented in this model by using command and data buffers identified by reference. Whether the commands are passed in as strings or pointers to command buffers is irrelevant. And whether the data is supplied as parameters to the command string or as another data buffer is also irrelevant. The exact execution method isn't of interest as much as that there is a defined standard for input and output.

As such, using the simplest possible method one might consider a data element could be a string for the value and another string to define the data type (command, buffer, etc). Pairs of these may be built up to define command and data buffers or as many lines of passed data as might be necessary for any possible system.

An example is that a filename is a reference string to the data buffer we consider a file. Of course it is assumed that the type is also of “file”.

Havingness in it's simplest form could be represented simply by a string for the value and another for the user-definable data type. Or it could be used in pairs such as for a command and data buffer there the buffer itself defines what the operation is as well as the returned data.

Typically Havingnesses are associated with their own values. While the implementation may choose to represent all values as Quanta links (see below) these values may also be stored directly here. Masses have weights. Files have sizes. Items have quantities (even in terms of count or other description). At the discretion of the specific implementation, these values may be part of the Havingness or simply associated as a Quanta link.

When designed as a Command & Message buffer, these may indicate the sizes of these buffers in units which are user-defined.

Space Space is by Name or coordinate (of any system). Naturally the type should be user definable. A list of points might define a line, an area or a volume. Name references might include such things as “Los Angeles”, “Paris”, or “Hong Kong” while one might also define these by the coordinates representing their physical boundaries.

Spatial relationships are defined here which include the 6-Degrees of Freedom in group triplets such as location and orientation. Any references to space or spatial distances are the domain of this element. Locations, Measurements, surface areas and volumes.

The container for this data should support descriptive references (such as names) as well as detailed references (coordinates). Since we live in a 3-dimensional universe, then the minimum number of values for any coordinate is three values—each of which must have it's own definable data type.

Three points only defines a point, however even a point has other attributes including yaw, pitch and roll, which make up another triplet. Since not every application requires both sets of information, we limit the groups to one set of three values and their associated data types (which could be numbers or strings for flexibility).

All references are considered relative to something else. There is technically no such thing as an “Absolute” address. If the referenced coordinate system is rotating (such as a planet) then the coordinates are also rotating (using the reference's motions).

This being the case, we enter into any coordinate (even pairs of triple values), another factor and that is the reference location. In an imaginary world this need not be create nor defined, however in the real world other spatial coordinates require the reference frame. A reference frame would use the same pair of triple values (the 6-degrees of freedom) and their associated user-definable data types.

Except for a descriptive string (such as “Los Angeles”) the most basic structure for a spatial value is three values (of any number format) and their user-definable data types (which could probably be strings)

Of course, one need not use every value to define something. A distance can simply use one of the three. And Area might include two of the three (such as height and width).

Energy While Space is a location, Energy represents the motions in Space. Force is vectored energy. It might be a Flow, Dispersal or a Ridge. When kinetic as a flow, one might express an explosion as the dispersal of forces from a common point. In other words all vectors would diverge from the common point (which can further be defined as a space). Implosions are simply the convergence of these flows.

Energy definitions are similar to those of Space in terms of descriptive names or referenced coordinates. Any spatial definition in motion is defined here. Just as one has coordinates for location and angles for orientation, so too does energy have coordinates however these are vectors. And the angular values are those for rotation as opposed to a stationary orientation.

Linear speed, expansion or direction would be considered in this element. Acceleration being a speed applied to another speed over time would simply be another link of a similar element with the inclusion of a time element.

So energy consists of the same triples one uses for space (coordinates and orientation) in terms of velocity and force (vector and angles), although one might want to consider the motion vector as separate from the force itself.

Of course, energy is a flow and a flow has certain properties including: the flow, dispersal or ridge form of the flow. These should be included in the element structure to properly define the flow.

It is important to note that Energy is not strictly defined as what we consider energy to be but also has various forms. For instance money is a form of energy—a solidified form. One works for a week (Doingness using Energy) which is converted into a solidified, unflowing form we call money. And we may decide to convert this solid form of energy back into a flow by purchasing something (like gasoline for a car) and making it do work again. Thus all accounting easily fits in here.

Energy flows from one place to another. By utilizing “from” and “to” (either as structural flags or positive/negative values for the vector) one could also show the flow of funds from one account to another (an account, of course being an abstract identity—a Beingness).

Time Time storage should be flexible enough to store any type of data (in full or in part). Like Space, it might be referenced by a name or the time itself. For instance, the “Jurassic Age”, “The Roman Era”, “The Middle Ages” are all valid time references.

And calendars are not the same either. Several have been in existence including the Chinese and Mayan calendars but also we have future calendars to map to things such as Moon or Mars.

The ideal time container would be one which allowed the user to submit incomplete time references as well as their own definitions for the units or data type. In ordinary terms, a text string works quite well when mapped out.

Of course one also references time numerically such as by day, month, year or hours, minutes and seconds (or any portion thereof). Ideally the physical structure should support this. And also one should never reject partial data when it exists. For instance, if one knew the month but not the day one might store just the month portion. If one knew the decade but not the exact year, one must be allowed to store that component of time.

Time consists of certain factors: 1) A Start Time, 2) A Duration, and 3) An End Time. Usually one has at least one of these known (in full or part). If one has two of them (in full) then the third is computable and might be included simply to aide in future queries. But one only includes the data to the degree he has it. This may be stored in an element as another triple or separated and identified with some indicator of which type it is (Start or Change/Duration or Stop).

Of course, Time is user-definable. While this might cause some design work, it is well worth the effort because not everyone uses the same time references. A Geologist's units might be in millions of years, while a Nuclear Physicist's might be in billionth's of a second.

From this we could derive a simple structure which could include a Start Time, Duration Time, End Time possibly including or in union (overlapping) with a potential name string (eg. “Middle Ages”). Of course every data type is user-defined as well as the fact that some values may be incomplete. And example of an incomplete time might be to know that something happened in the 1980's but not knowing exactly which year. Obviously one wouldn't want exact values entering into a system where these are not exactly known. One solution to this might be to store these values as strings (e.g. “198_” there the omitted number represents the unknown year). In this way, one could search for something happen in 1980 or 1984 and still come up with a matching result (as the omitted field could be considered a match). This is but one of many potential solutions representing how one can utilize incomplete time data.

Since there are so many languages, tools and methods of representing any type of data, it is not the intent of this application to define the exact specifications of each field and data type for any element. These definitions are left up to the specific implementation, however examples are provided herein of how they could be defined for use.

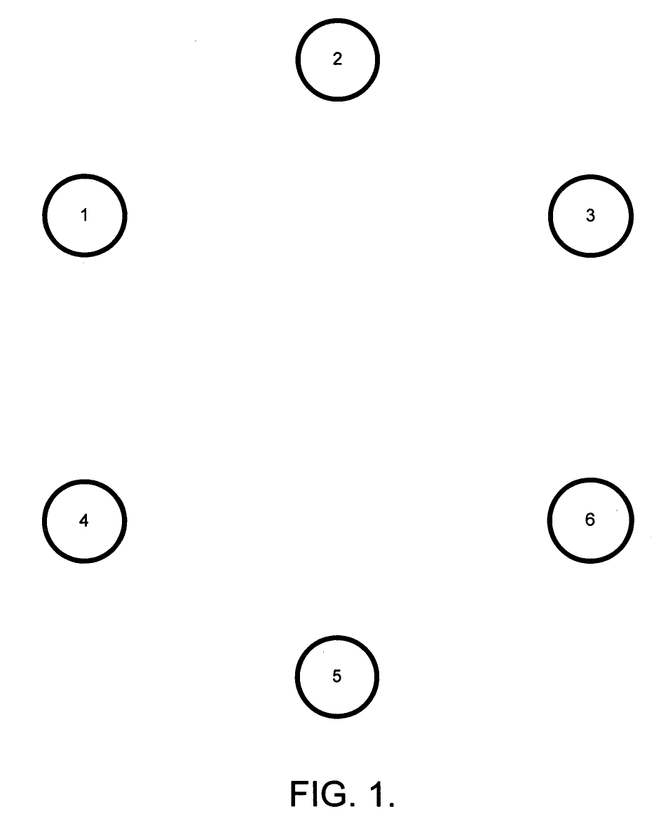

FIG. 1 illustrates the core elements as nodes. It is to be understood the term “element” is used to represent a logical description of the database table, while “node” is used to represent the physical description of the database table. As to the active table of contents, this is beyond the scope of the present application and dependent upon the application of the invention. However, for explanatory purposes, and with reference to FIGS. 1-7, the primary six core nodes have been assigned the following reference numbers: In this figure and throughout the drawings, all Nodes area assigned a 1-digit number with the following numbering convention: Beingness or Be, with the reference number 1; Doingness or Do, with the reference number 2; Havingness or Have, with the reference number 3; Space, with the reference number 4; Energy, with the reference number 5; and Time, with the reference number 6. The reference number 9 is used generically to represent any of the nodes or elements.

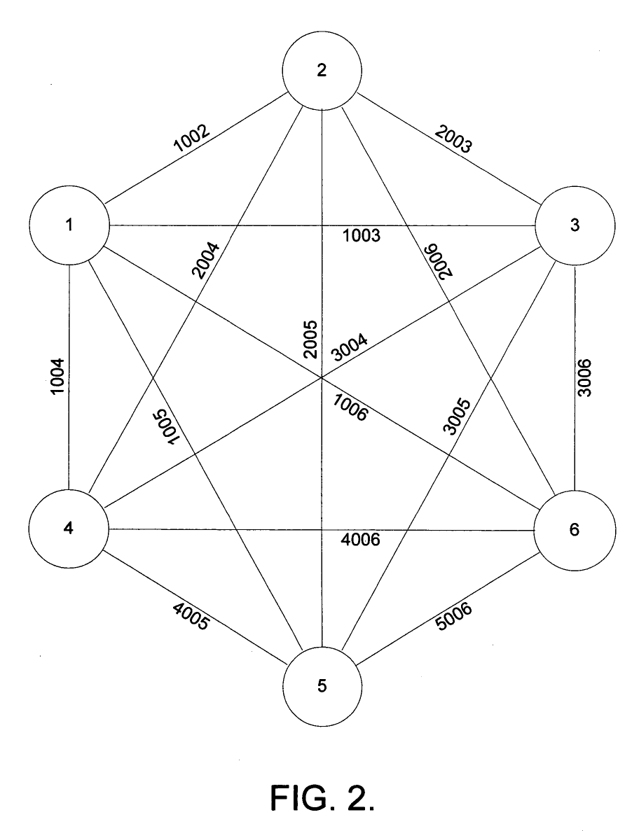

With reference now to FIG. 2, the connections, linkes or logical flow for each of the primary six BDH-SET nodes is illustrated. It will be noted that every node is connected to each and every node (including itself—identified below as “Flow Zero”). The number reference designation for such flows or links is designated herein by the element or node to another element or node, in logical representation. A single digit element/node reference number (1-6) will always be the first digit padded with a zero (0) behind it in order to make it a two-digit number. In the logical diagram of FIG. 2, when a first and second element or node are interconnected, the second element or node will be the last digit behind a leading zero, such that nodes 1 and 2 (Beingness and Doingness) show the linkage as being 1002. Thus, connecting lines between the Be element or node 1 and space element or node 4 would be as follows: Be 1 to Space 4 as 1004. The connecting line between Do 2 and Space 4 is represented as 2004, etc. The remaining linkages follow this numbering convention with the lower number being represented before a higher number.

Link Nodes.

One Datum by itself is meaningless. It can only be evaluated by comparing it to another datum of comparable magnitude. That is the purpose of the relationships as established by Link Nodes and Link Link Nodes.

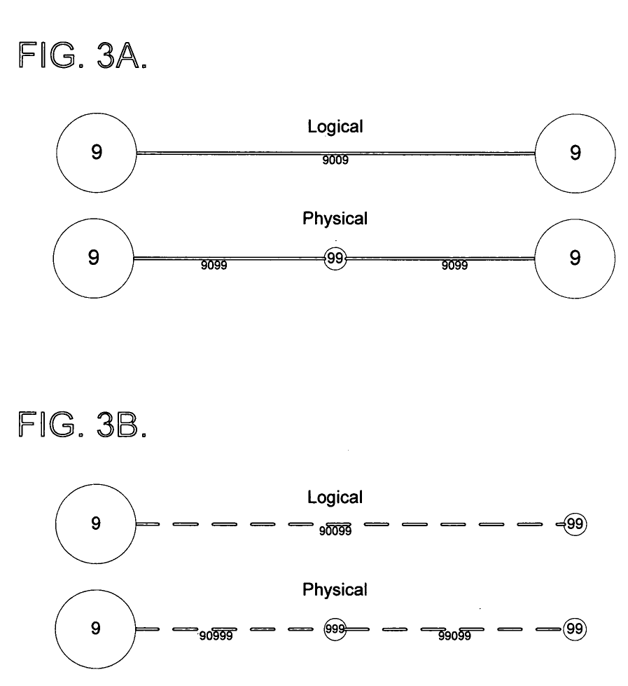

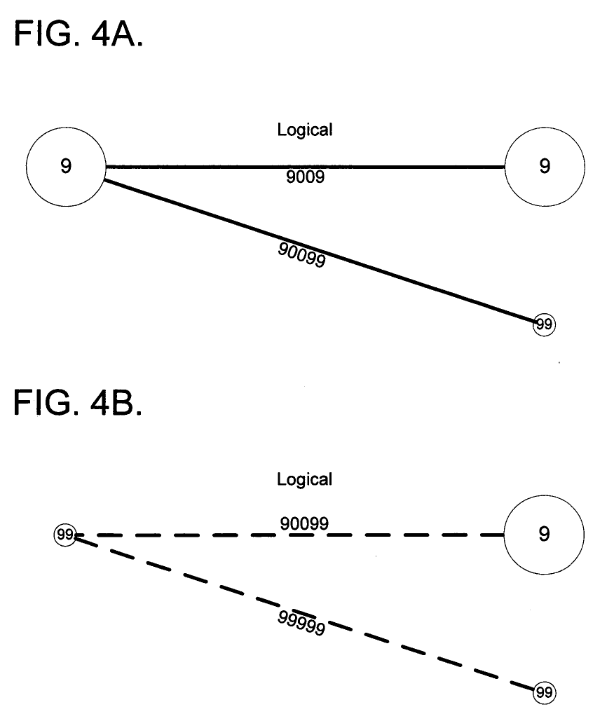

The underlying simplicity of the system of the present invention is that it uses only two types of connections: A Node to a Link Node, and a Link Node to a Link Node, as shown in FIGS. 3 and 4. These connections are used to create the entire system.

With reference to FIG. 3A, logical and physical connections or links between nodes, between nodes and a link node, and between link nodes are illustrated. While the Nodes themselves are single digit numbers, the Link Nodes between these nodes are identified by the node numbers which they connect, thus producing a two-digit number. For example, while a link between Node 4 (Havingness) and Node 5 (Space) would be identified as Link 4005, the Link Node between Nodes 4 & 5 would be identified as Link Node 45. All other Link nodes use the same numbering convention with respect to the nodes they connect.

Further, a Node is physically attached to a Link Node and then to the other Node, so the physical connection isn't simply from Node-to-Node but rather from a Node to a Link Node and then to the other Node. So the connection between a Node and it's interconnecting Link Node is identified in a similar fashion to the node link convention—it is a 4-digit number. Just as Link 1002 connects Nodes 1 to Node 2 (with an implied Link Node 12 between them), so does the Link 1012 connect Node 1 to Link Node 12 (which connects to Node 2 using another Link—2012). By convention the Node is identified as a single digit followed by a zero (filling it to 2-digits), while a Link Node (already 2-digits) is listed after. For example, a link between Node 4 and Link Node 46 would be identified as Link 4046. All other Node-to-Link Node connections follow this convention.

FIG. 3B further illustrates that a Node can be connected to a Link Node between any two other Nodes. This is called “Flow 3” (which is further described below). This connection is labeled using a 5-digit number. From a high-level of a Node connected to the Link Node of another connection, the first digit represents the Node, padded by three zeros and the final two digits representing the Link Node number between the other Nodes. For example, a “Flow 3” connection from Node 1 to the Link Node 46 (between Nodes 4 and 6) would be Link 10046. And a connection between Node 3 and Link Node 25 would be Link 30025. By convention the Node always comes first and the numbers are always in a rising sequence (i.e. 2 before 5).

Further, while this Node being connected to the Link Node connecting any two other Nodes, would technically require another Link Node to link the Node with the Link Node. This type of Link Node is referred to as a “Link-Link Node” (a “flow 3” connection). All links to or from this Link-Link Node are 5-digit numbers.

Node is connected to that Link Node by what is called a “Link Link Node”. Following the convention already established, this Link Link Node receives the number of the components it attaches: a Node at one end and a Link Node at the other. Since the Node is 1-digit and the Link Node is 2-digit, this results in the Link-Link Node having a 3-digit identifier. For example, a Link-Link Node connecting Node 4 and Link Node 13 is Link Link Node 413 (by convention the Node always precedes the Link Node).

As the connections to the Link-Link Node generates connections between the Node and the Link-Link Node and also between the Link-Link Node and the Link Node, these connections are represented by 5-digit numbers. For example, the connection between Node 3 and the Link Node 45 would result in Link 30345 between the Node and the Link-Link Node and Link 45345 between the Link Node and the Link-Link Node. The convention being that the Node (trailing zero padded) or the Link Node represent the first two digits and the Link Link Node be the remaining three.

FIG. 4 illustrates all the connections necessary to build this system. As in FIG. 4A, all Nodes can be attached to either a Node or a Link Node, and as in FIG. 4B, all Link Nodes can be connected to a Node or another Link Node (technically a “Link Link Node”). Optimizing these two connections optimizes the system in general.

Whereas, the data storing primary nodes represent a different specific characteristic (BDH-SET), sometimes referred to as values and data types, the link nodes have assigned identifications and data relating to the two nodes the Link Node connects.

Whereas, the data-storing primary nodes represent a different specific characteristic (BDH-SET), sometimes referred to as values or data types, the link nodes have assigned identifications and data relating to the two nodes the link node connects.

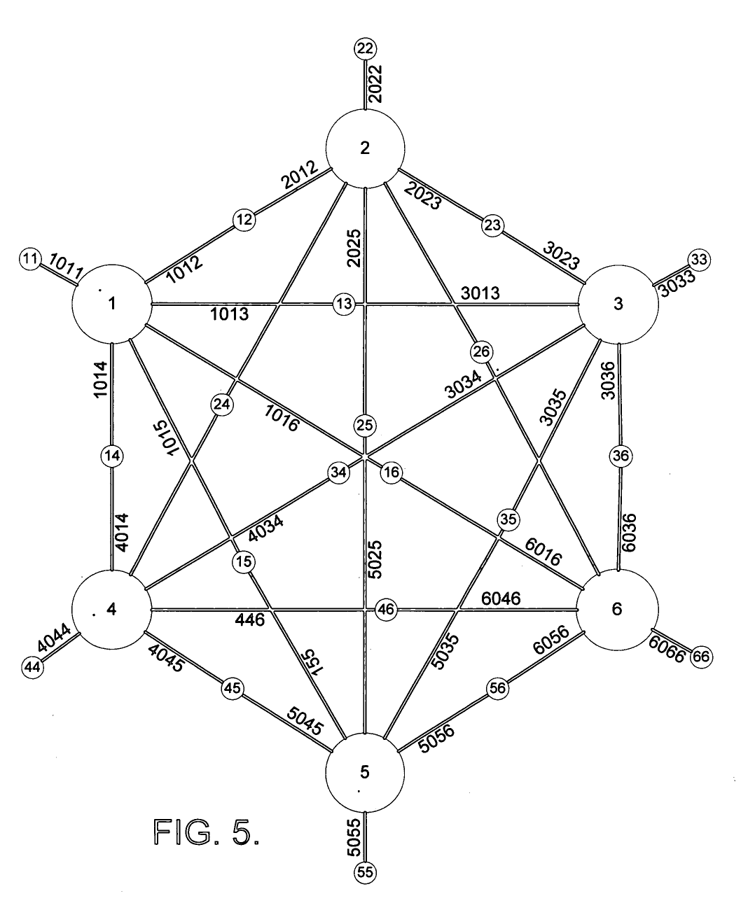

FIG. 5. illustrates the application of all Node and Link Node connections using the connection types described in FIG. 3A. This shows all Nodes connected to all other Nodes via Link Nodes. Also, it should be noted that each Node is also linked to itself using a Link Node to itself, as represented in this illustration.

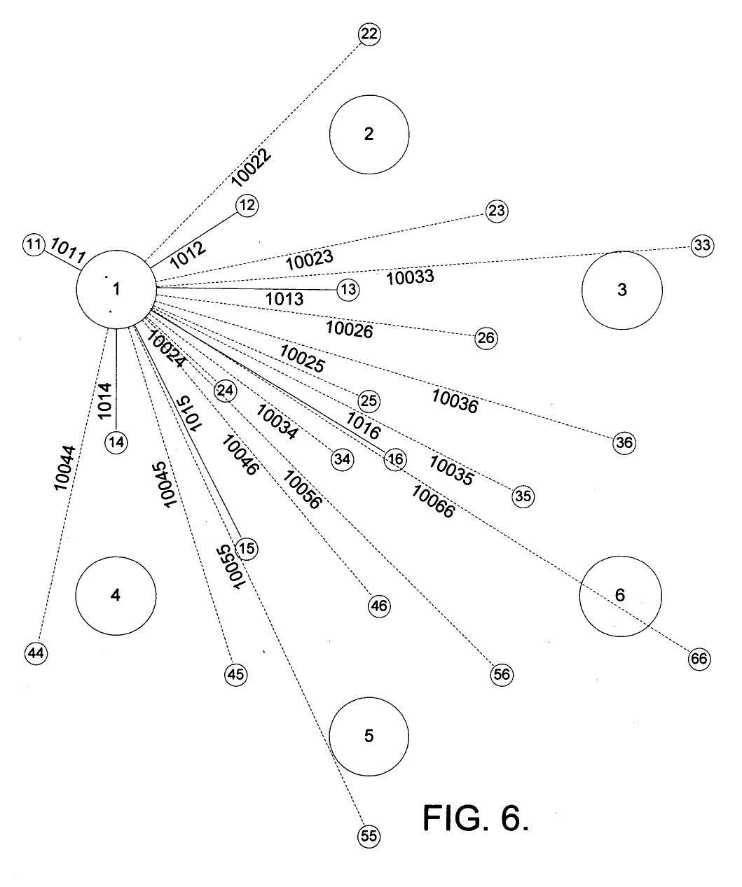

As all Nodes are attached to any other Node and also all the Link Nodes between those Nodes, FIG. 6. illustrates all the possible connections which can be made from a single node—here exemplified by Node 1 connected to all the Link Node and Link-Link Nodes in this system. However, the remaining primary nodes 2-6 would also have similar connections and links, not only to Link Nodes but all Link-Link Nodes in accordance to the description for those link types described above. These would represent all Connections of Nodes and Link Nodes as described in FIGS. 3A and 3B. With this paradigm, there are Link Node and Link-Link Nodes assigned identification and data relating to the Node and Link Node which would connect non-self nodes to “other” nodes. Such a connection is illustrated in FIG. 4B, wherein a link node (numerically referred by the reference number 99) is linked or connected to another link node (also generically identified by the reference number 99).

Flows

There are four types of relationships from one datum to another. These are called “flows” numbered zero (0) through three (3). All links are two-way.

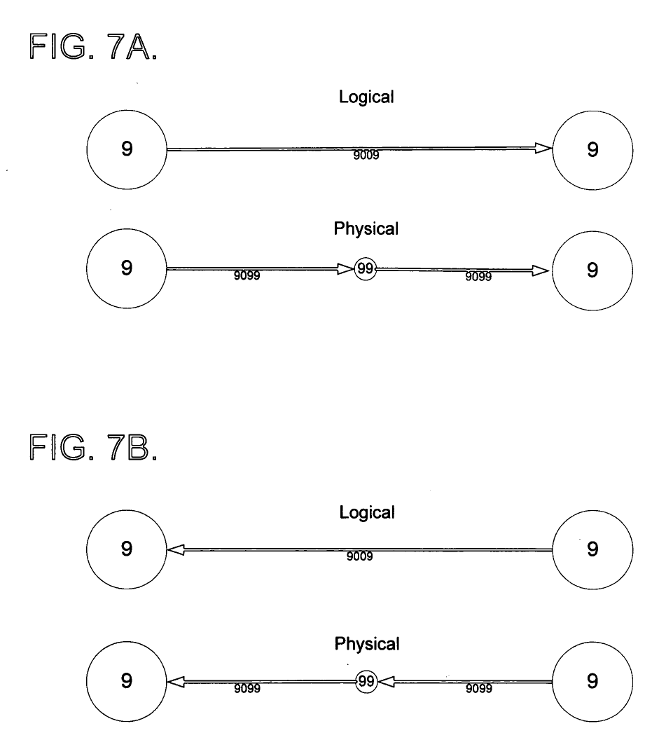

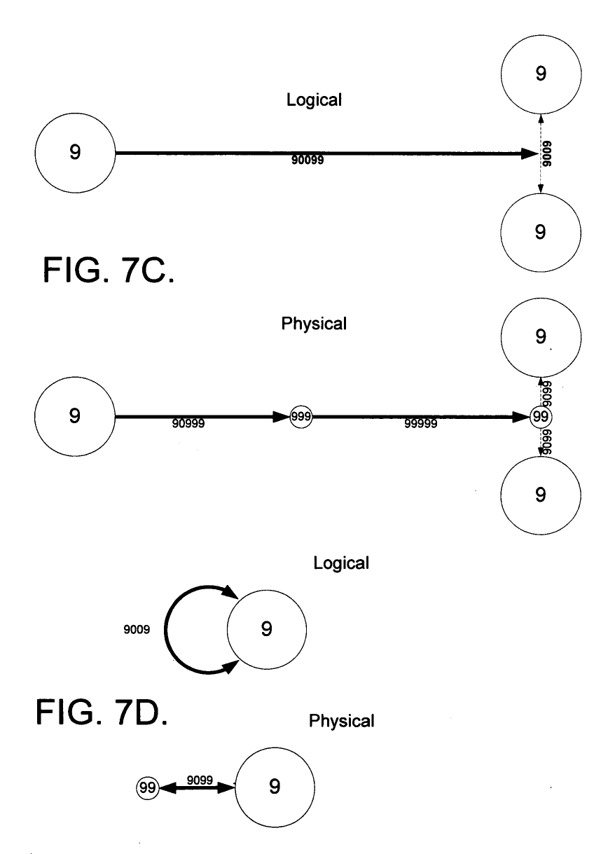

Flow 1 is “Self to Others” as represented in FIG. 7A. This is the link between a reference element and some other. This is essentially an “outflow” type of reference to other elements using the source reference.

Flow one can be used as a starting point in a search for other data, or to follow chains of data beyond the initial reference (self) where the target (other) is of more interest than the initial reference (self). Interest is beyond the reference (self).

Flow 2 is “Others to Self as represented in FIG. 7B. This is the link between another element to the reference element. This is essentially an “inflow” type of reference from other elements using the source reference such as “pulling outside information to oneself.”

Flow 2 can be used to utilize other known data in order to find the unknown self, or to collect up information around a known reference (self) while not “searching” other routes. Usually the reference (self is of more interest than the other information. Interest is focused on the reference (self).

Flow 3 is “Others to Others” as represented in FIG. 7C. This is the link between an Element and the association of two other elements. This is generally used to determine some reference element association with respect to the relationship between two other elements. It will be explained in greater depth later in this document as there are many things one can do with this relationship.

Flow 0 is “Self to Self” as represented in FIG. 7D. This is the link of the reference element to itself. This is generally used to determine chains of information or relationships such as seniority or grouping of sets.

These Four Flows are the primary methods of association of any element with another (including itself).

FIG. 2 shows how the Logical Flows 1 & 2 as represented for the primary (6) elements. FIG. 6 is a physical representation for a 6-element model which is expanded to include Flows 0, 1 & 2.

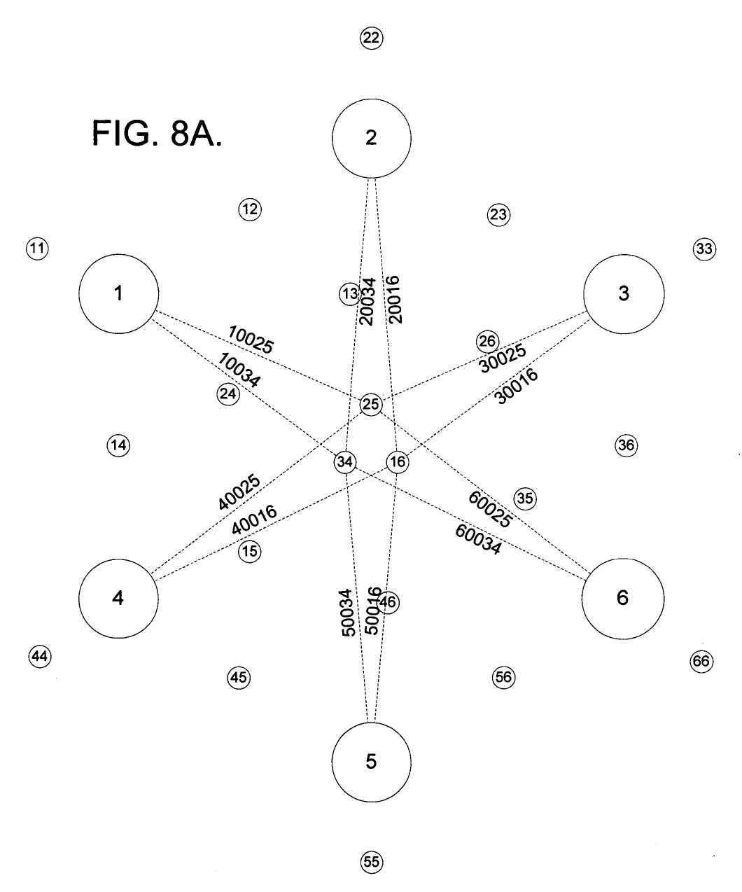

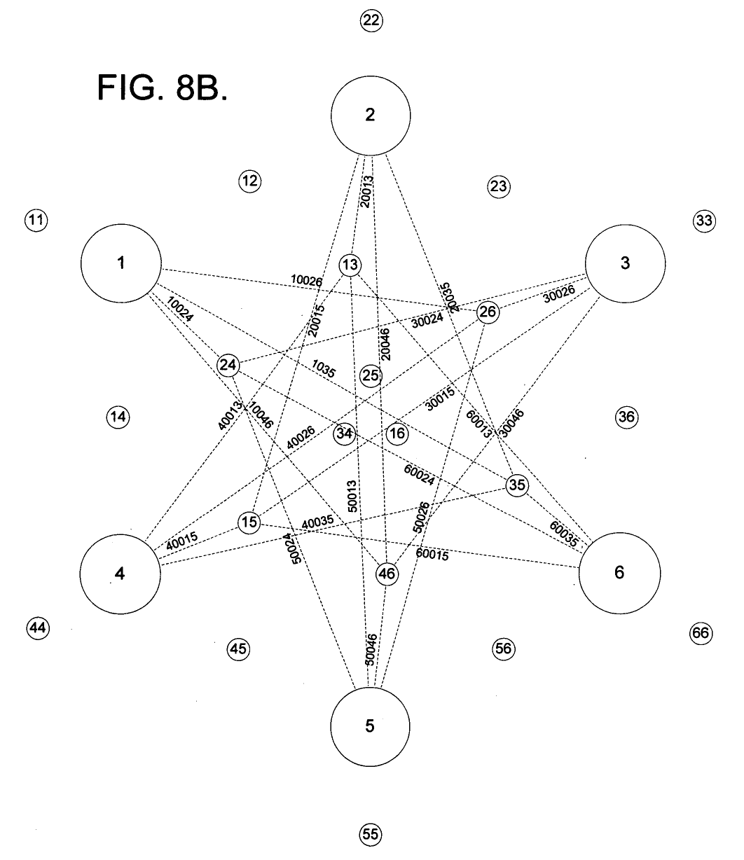

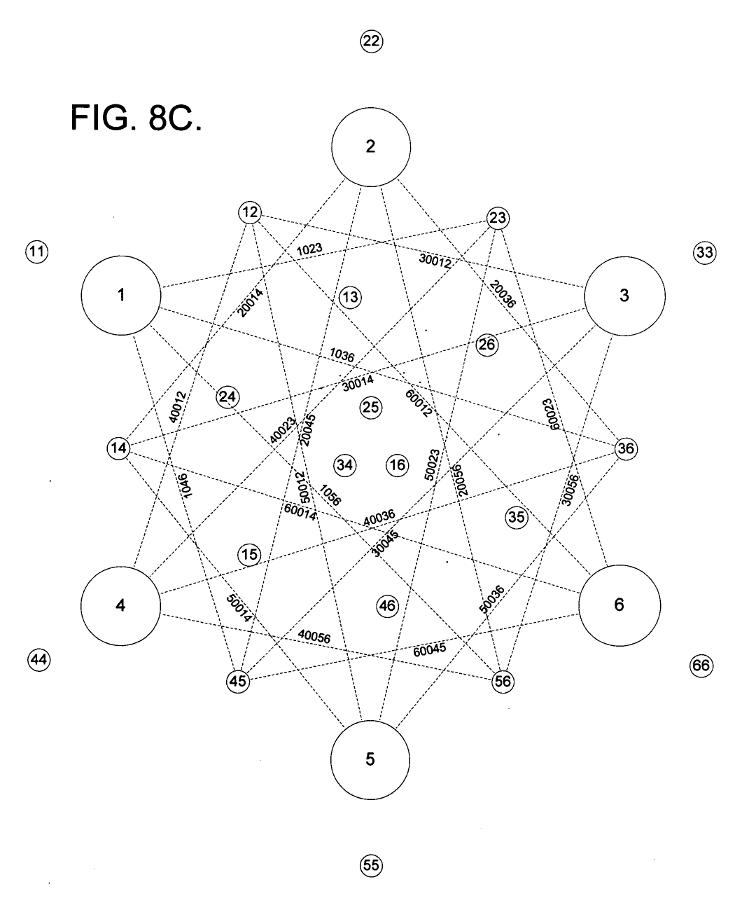

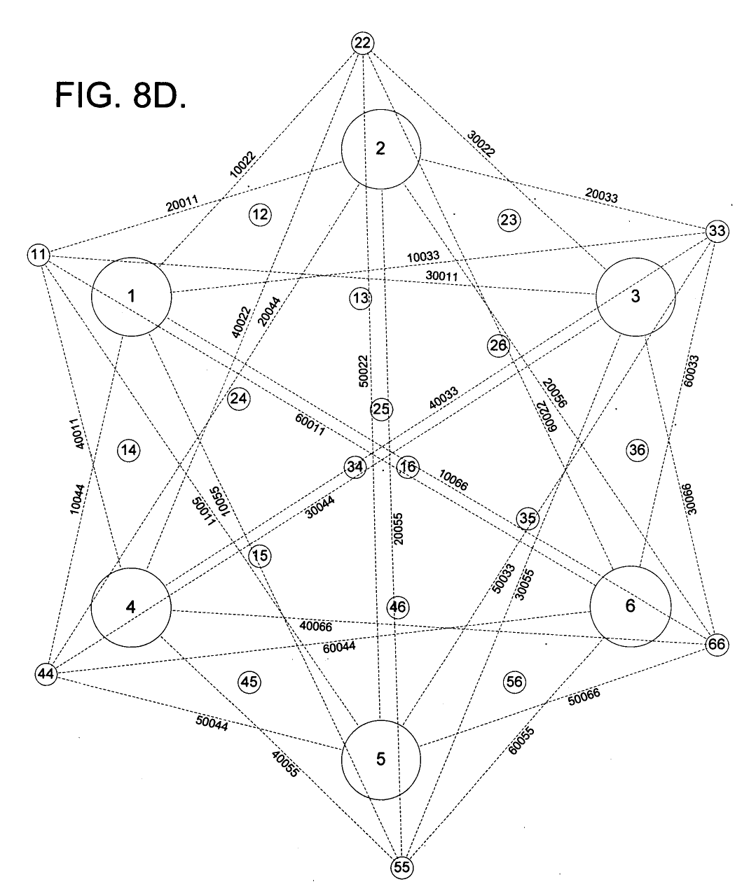

However Flow 3 is cumbersome to display (even for the Core 6 Elements) as it basically represents all the connections that can be made from a node to any link node. Even for a single node of a 6-node model it can look pretty complex. In order to simplify the diagrams as well as show all Flow 3 connections, they have been broken down into layers. The layers for the Primary 6-Element version are broken down in FIGS. 8A through 8D.

Logics. A failure of previous database models is that they tend to link data based upon an association but not a complete “logical association”, which is meant the three logical relationships of any datum with another.

It is required of this model that Logics be included in all data relationships.

There are three types of relations which are defined by logic itself. These relationships are:
1) Identities—An Identity means that the two datum are considered to be the same, one with the other.
2) Similarities—A Similarity means that the two datum are considered not identical nor different but are similar by association in some way.
3) Differences—A Difference means that the two datum are considered not to be identical nor similar in any way.

Most databases define relationships which are either Identities or Similarities but rarely Differences. And even the precise nature of the relationship is mostly assumed by the designer. In this model this information is not left up to the application but explicitly defined within the data structures. From this we derive the logical relationships between any two datum.

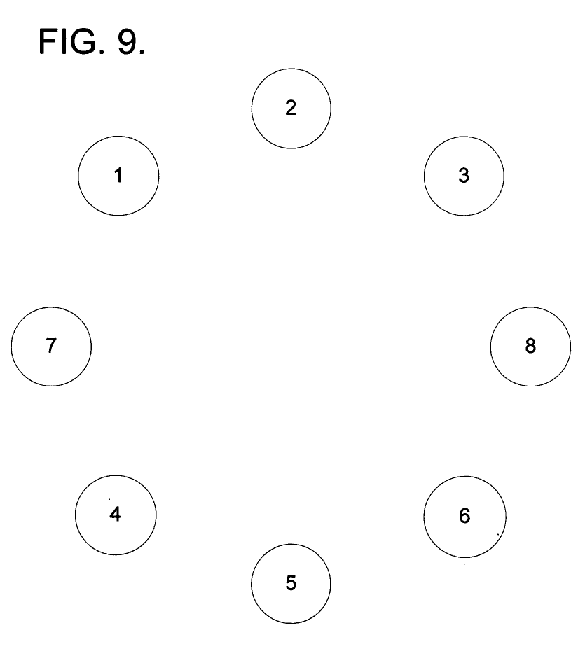

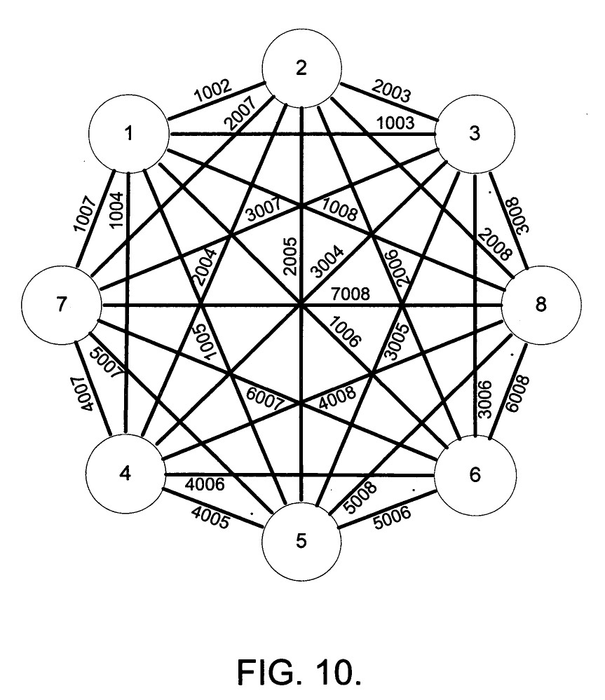

In order to fit all types of data (in the physical world as well as virtual universes) and all requirements that might need to be made by the universal database system of the present invention, a couple of abstracts elements were added. Namely, the nodes of Quanta, assigned the reference node number 7, and Modifier, assigned the reference node number 8. As illustrated in FIG. 9, these eight primary nodes, with pertinent links and link nodes, as illustrated in FIGS. 10-12, form an unchanging and universal database model and system.

With respect to the reference numbering in FIGS. 9-12, the same convention as described above is used. That is, while the Quanta element or node is assigned reference number 7, the Be-Quanta link node is assigned the reference number 17. Similarly, the modifier element or node is assigned reference number 8, and the Do-Modifier link node is assigned reference number 28. Connections or links are as described above, with the lower numbered node or link node listed first, and the higher digit node or link node listed last, and where referencing a Node, padding the number with at least one zero between—as described previously. For example, the connection line between Quanta (node 7) and Space-Time link (Link Node 46) is 7046.

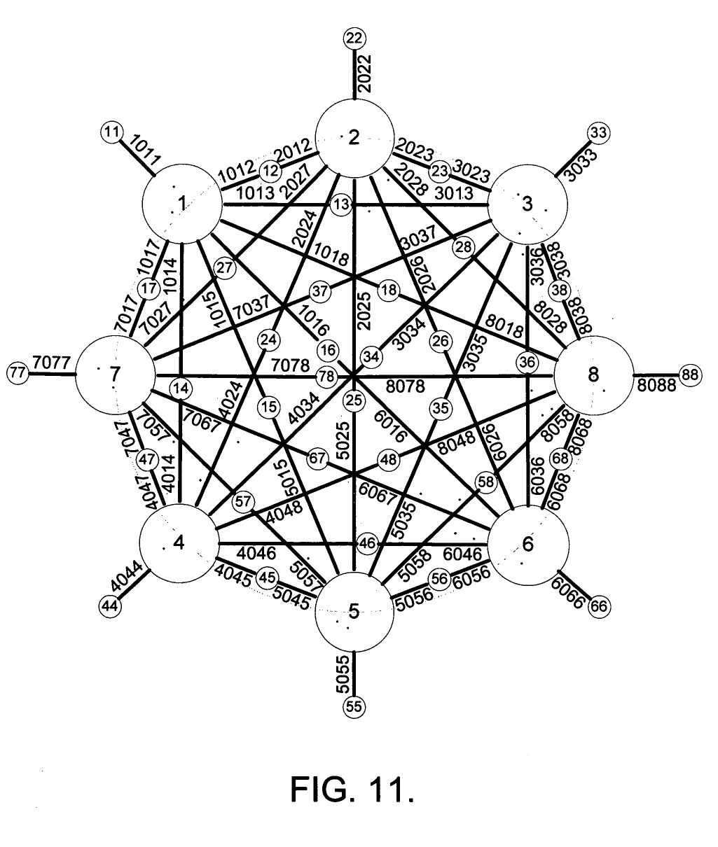

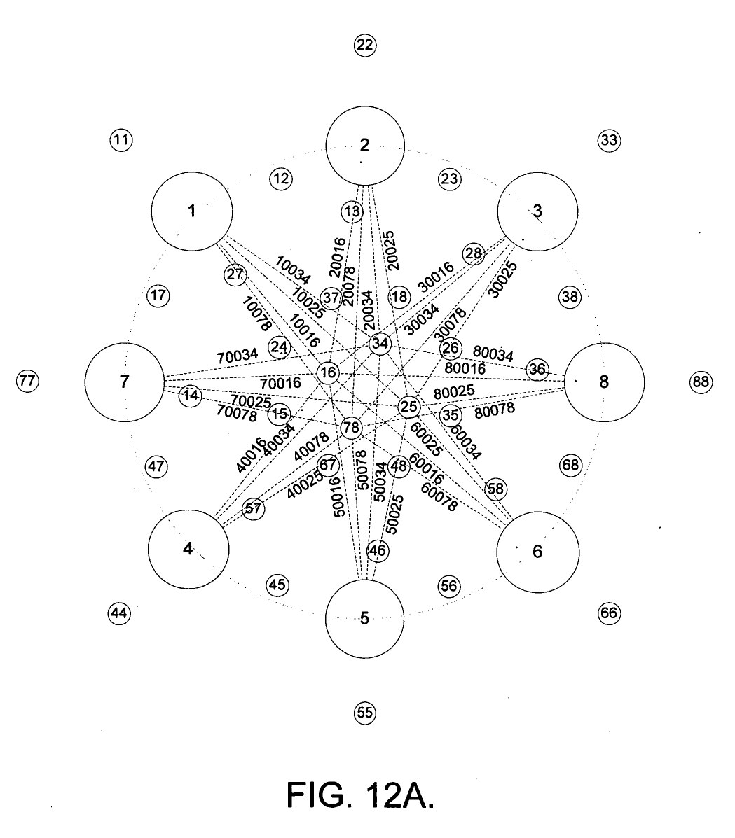

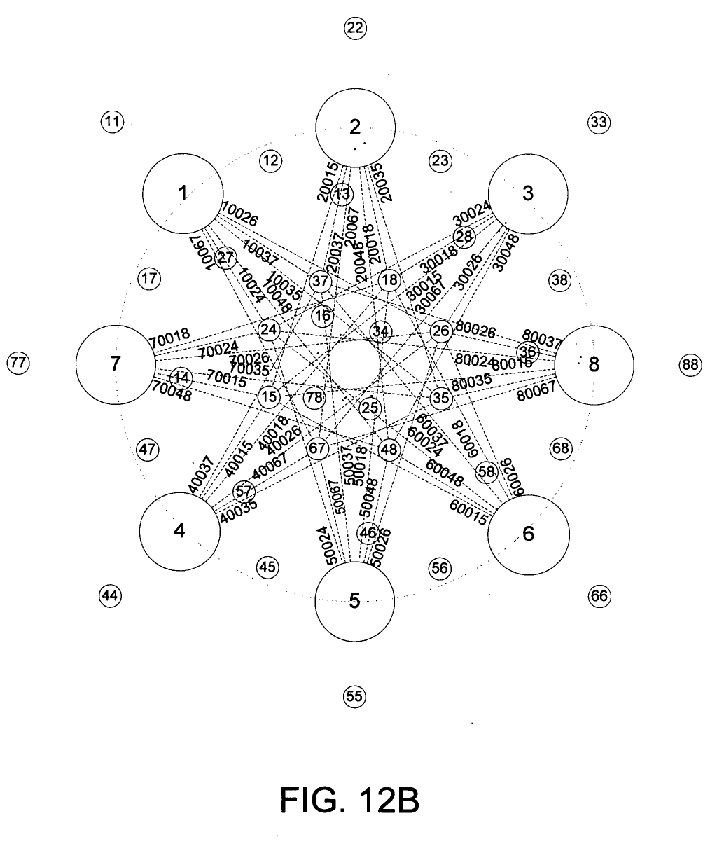

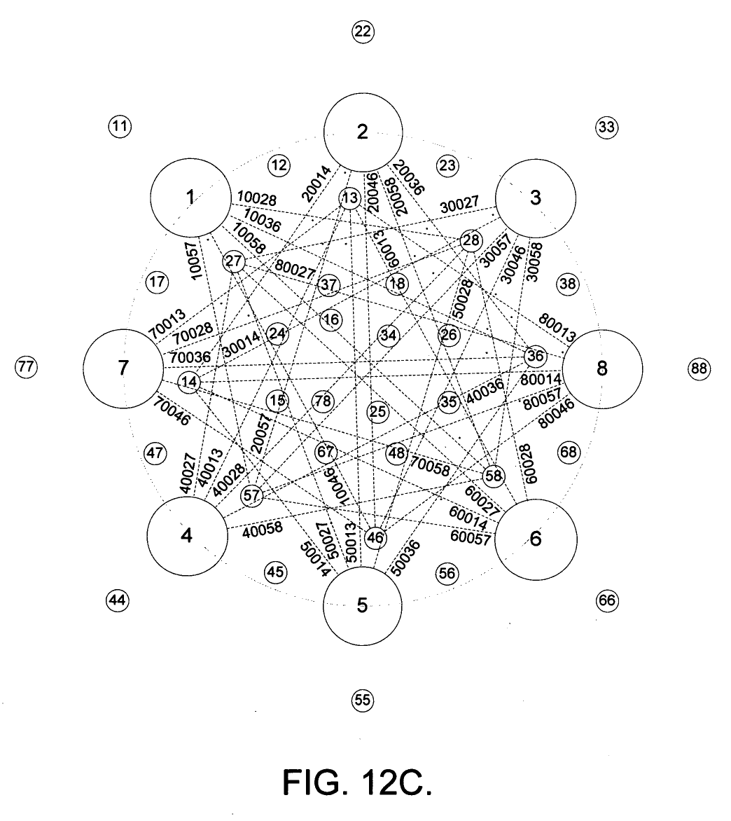

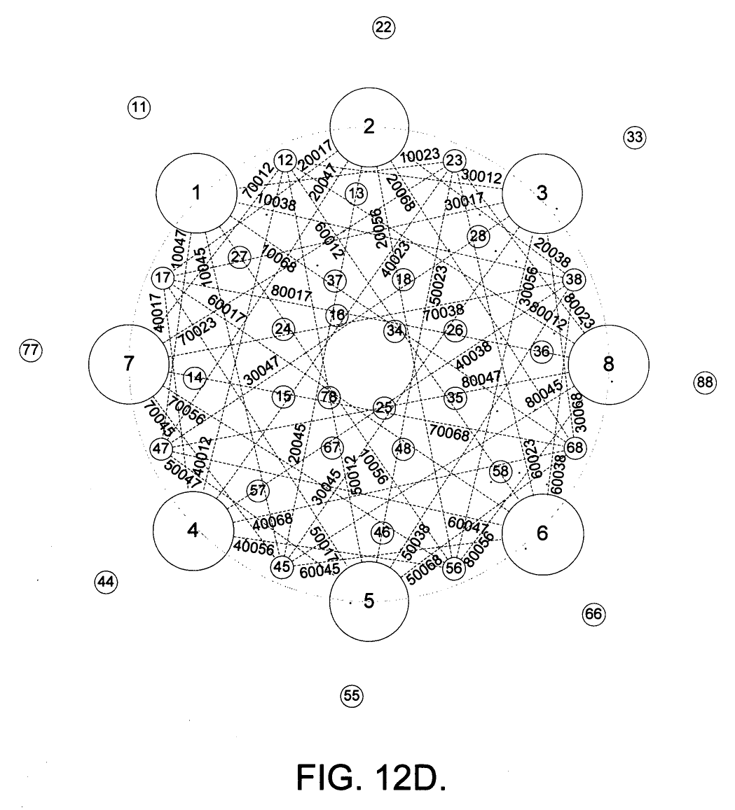

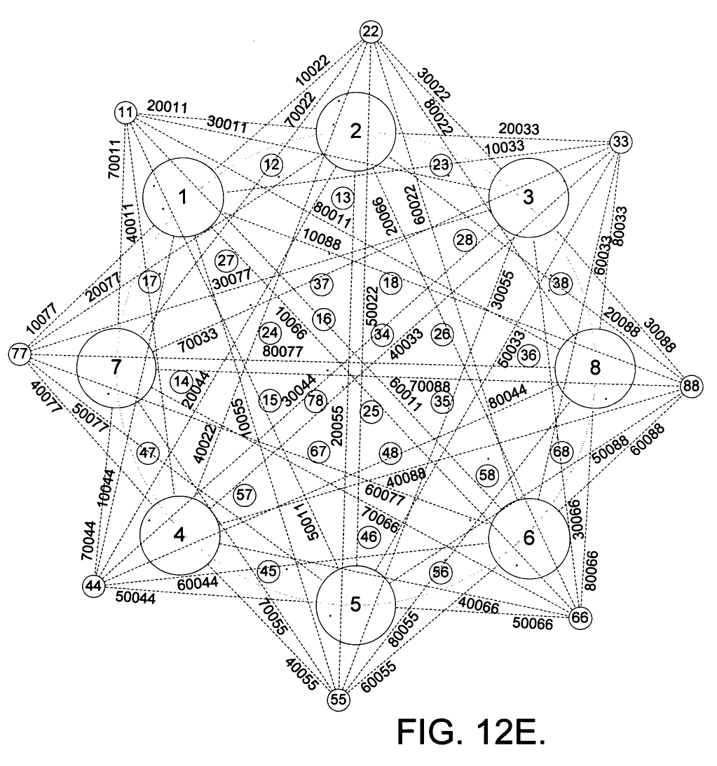

The interconnection of the primary nodes 1-8 is illustrated in FIG. 10 and illustrates flow 1 and 2 between the primary nodes. FIG. 11 illustrates flow 0, 1, and 2 of the eight primary nodes. FIGS. 12A-E, illustrate layers 1-5 of flow 3 of the eight nodes, respectively.

Quanta

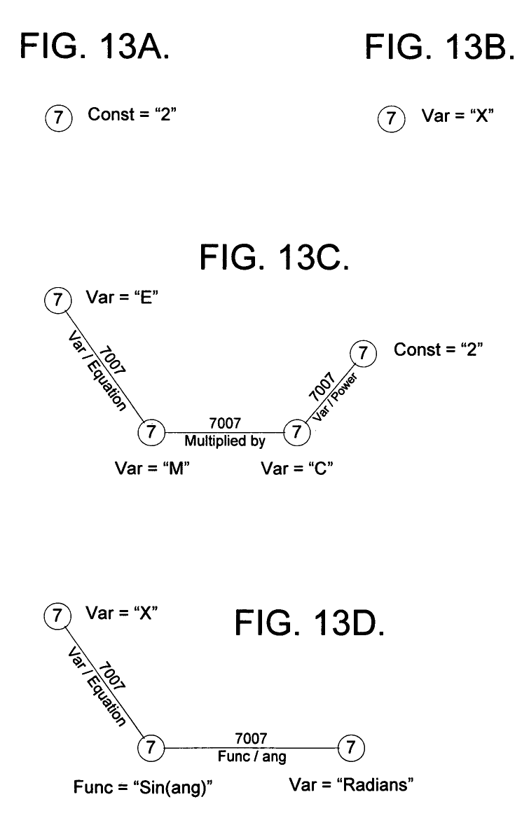

Quanta comes in three forms: (A) Constants, (B) Variables, and (C) Equations, as shown in FIGS. 13A-D.

A Constant is a known number or value. It might be used to store a known quantity such as the mass or count of a Havingness where the mass or count was definitely known.

A Variable is a placeholder where the value or content is not known. This is the foundation of algebra and other higher mathematics.

And an Equation is a more complex set of formulas which define the value or association of any Quanta to any other. An Example might be E=MCˆ2 where the Element would contain “E” (a variable) which is further linked to Elements containing “M” (a variable) and “C” (a variable) which is linked to a constant defined as the power representing the known constant value of “2”.

Using such a method of storage, it might be possible to further develop mathematical computers which could re-use standard Element relationships in order to solve higher mathematical equations by finding routes where a value is already solved.

Just to list a few uses for this element:

As a Constant, related to Havingness, it might be used for Counts, Mass, weight, etc. Related to Space it might be used for Lengths, Areas or Volumes. Related to Energy it might be a combined value as something to include with the original energies stored in that Element.

As a Variable, for Doingness might be the unknown rate of action or speed. For Havingness, once again we consider unknown quantities and masses. For Spaces, we have again the linear distances, areas and volumes of things when the value is unknown.

As an Equation, we could represent any type of mathematical equation including those where one or more values are unknown. Here are a few samples:
E=M*C^{2,}
F=M*A
A=V*T,
V=S*T,

In the above list, we see that A is defined from an equation, and even if we didn't know the value of A in the 2nd Formula above, we might be able get it because it would also be linked as the output of another equation which (for the sake of this discussion) we have the answer to.

Of course we're not limited to variable as there are common functions used in mathematics which we could take advantage of including:
Sum( )
Cnt( )
Max( )
Min( )
Sine( )
Cosine( )
Tangent( )
ArcTan( )
Logirithm( ),

Typically a function would be applied to pre-defined parameters which are linked to the function node with the link indicating the parameter type—as listed in the function definition. Designed properly (with equations linked to their references in other equations) it might be possible to derive new equations or solutions from existing formulas even using artificial techniques. At least this is an implied capability by this technology.

Once again we get back to examples of how one might create such an element. For a strictly numeric field it is easy as we'd simply define a numeric data type. However, since this a very polymorphic type, we could construct this using anything from strings to other object oriented structures using the defined types (constants, variables, equations or even functions). A string would simply be parsed by the engine, while the object values would be called directly for their own returned results. The data type should be user-definable such as a string or other indicator.

Modifier

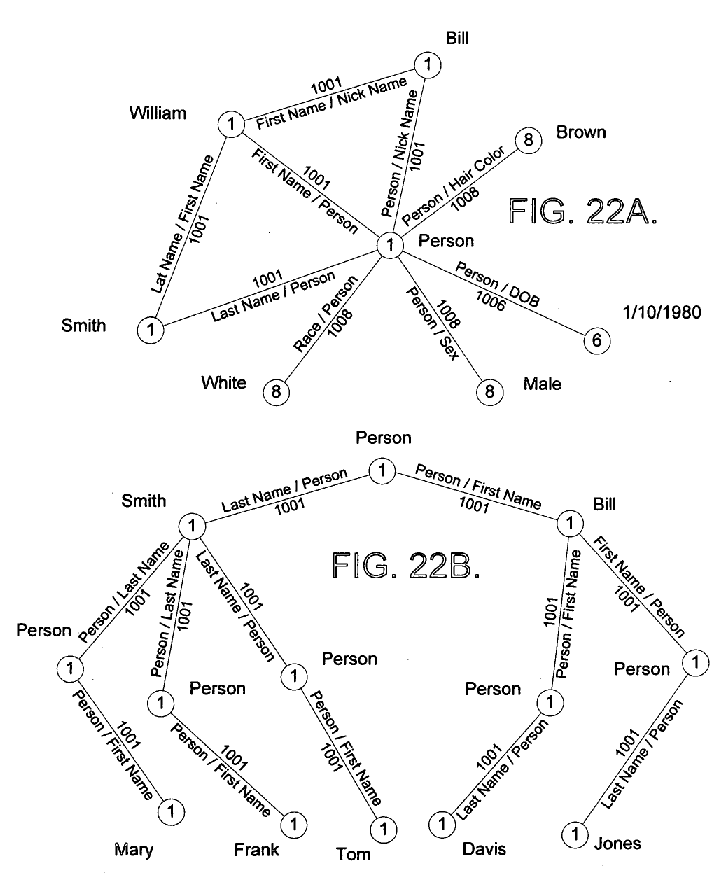

A modifier is used to define the attributes of something. If we were investigating a crime scene (as described in Beingness above) we'd be collecting things which included descriptions of someone (white, male, blue eyes, brown hair, etc). From a large enough collection of common data one might be able to isolate and eventually locate the fugitive. An example of this would be as illustrated in FIG. 22A. assuming that one didn't yet have the name of the suspect.

For the most part this could be considered an adjective (Beingness, Havingness, Space, Energy, Time) but for Doingness it is called an adverb. (One ties common modifiers to Elements, reusing the Modifier as well as making the Modifier itself a searchable element.

A Modifier is probably the easiest to consider in terms of structure. As a description it is typically text used to describe something—in any language. The structure for this element should support this string as well as it's user-defined data type.

Structures & Database Engines

Simplification (NLN, NLL)

Most database engines rely on unknown standard table structures—after all, any developer is expected to be able to design their own tables and schemas. Since there are so few unique Elements and these are known, such a system could be designed & built without much effort and could be highly optimized—beyond what might be possible with dynamic tables or schemas, and would probably be far more efficient than systems which rely on an impossibly large number of tables each with unique structures and relationships.

The underlying simplicity of this system is that it uses only two types of connections: A) a Node to a Link Node (NLN), and B) a Link Node to a Link Node (NLL), as shown in FIG. 4. From this everything else can be built which is far simpler in comparison to the core system designs of the more complex solutions in use today.

It would be capable of developing this technology into a hardware form such as on a silicon chip having 8 lines. Each line would indicate an element. A signal from any one of the lines or any combination of lines would indicate anything from a specific Node to which Link Node or Link-Link Node might be indicated (from the tables below). The result of the signals on the leads could be used either to direct processing, a search result or as an address of the Node/Link Node/Link-Link Node being processed or accessed. And there are many more potential uses made possible by this standard model. The fact that there these 8 elements encompass any known type of information as well as that this happens to be a binary number makes this highly efficient

As a signal generator or switch, this type of hardware could easily drive large masses of external data just as the CPU does in a standard computer. As an intelligent bridge and director of data, this could be a highly efficient form of analytic processor.

One version of such a chip could be used to interpret or reference which Element, Link Node or Link-Link Node to take action with. Another version of it could be simply the indication of a result such as a binary signal used for a match for a search. Or even a network/process director to indicate which direction to traverse.

This model supports a number of embedded hardware solutions. And these types of solutions (described above) would also work as a software solution—where software represented the functions described above.

Node Matrix

As indicated in the diagrams discussed earlier, the nodes themselves are linked to every other node (including itself). So for each node in the model there is be a connection to that node by every other node in the system (including itself).

Link Node (LN) Matrix

The nodes themselves are linked to every other node (including itself). So for every node in the model there would be a connection to that node by every other node in the system.

This matrix looks like this: (using the Node Letters rather than their numbers)

TABLE 1.1
Node to Link Node Matrix (by Node Letter)

| | Be | Do | Have | Space | Energy | Time | Quanta | Modifier |
|---|---|---|---|---|---|---|---|---|
| Be | BB | BD | BH | BS | BE | BT | BQ | BM |
| Do | — | DD | DH | DS | DE | DT | DQ | DM |
| Have | — | — | HH | HS | HE | HT | HQ | HM |
| Space | — | — | — | SS | SE | ST | SQ | SM |
| Energy | — | — | — | — | EE | ST | SQ | EM |
| Time | — | — | — | — | — | TT | TQ | TM |
| Quanta | — | — | — | — | — | — | QQ | QM |
| Modi- | — | — | — | — | — | — | — | MM |
| fier | | | | | | | | |

The omissions are simply duplicates of those already existing. Technically BT and TB are the same connection, however these are commonly referenced in the sequence priority as listed above. Any limitation to conform to this rule would be an implementation issue and is left to the implementer to determine whether or not to grant the user the ability to re-order the references.

The nodes which reference themselves (e.g. BB, DD, HH, etc.) are Flow 0 connections, while the others are Flow 1 or Flow 2 connections.

Link-Link Node (LLN) Matrix

In order to produce Flow 3, one must also attach every Node to every Link Node connecting any other two Nodes (not including itself since this can be accomplished by another Flow Link Node connection).

The matrix for this is complex. For each Node there is a connection to one of the Link Nodes listed in Table 1.1. Even for just the Primary Elements (the first six) it produces what seems to be a complex system—and even more complex to an 8-node system.

The following are the Link-Link Node listings for the entire system.

TABLE 3.1
Node to Link—Link Node Matrix for Beingness

| | | | | | En- | | | Modi- |
|---|---|---|---|---|---|---|---|---|
| Be | Be | Do | Have | Space | ergy | Time | Quanta | fier |
| Be | * | * | * | * | * | * | * | * |
| Do | — | B-DD | B-DH | B-DS | B-DE | B-DT | B-DQ | B-DM |
| Have | — | — | B-HH | B-HS | B-HE | B-HT | B-HQ | B-HM |
| Space | — | — | — | B-SS | B-SE | B-ST | B-SQ | B-SM |
| Energy | — | — | — | — | B-EE | B-ST | B-SQ | B-EM |
| Time | — | — | — | — | — | B-TT | B-TQ | B-TM |
| Quanta | — | — | — | — | — | — | B-QQ | B-QM |
| Modi- | — | — | — | — | — | — | — | B-MM |
| fier | | | | | | | | |

TABLE 3.2
Node to Link—Link Node Matrix for Doingness

| | | | | | | | | Modi- |
|---|---|---|---|---|---|---|---|---|
| Do | Be | Do | Have | Space | Energy | Time | Quanta | fier |
| Be | D-BB | * | D-BH | D-BS | D-BE | D-BT | D-BQ | D-BM |
| Do | — | * | * | * | * | * | * | * |
| Have | — | — | D-HH | D-HS | D-HE | D-HT | D-HQ | D-HM |
| Space | — | — | — | D-SS | D-SE | D-ST | D-SQ | D-SM |
| Energy | — | — | — | — | D-EE | D-ST | D-SQ | D-EM |
| Time | — | — | — | — | — | D-TT | D-TQ | D-TM |
| Quanta | — | — | — | — | — | — | D-QQ | D-QM |
| Modi- | — | — | — | — | — | — | — | D-MM |
| fier | | | | | | | | |

TABLE 3.3
Node to Link—Link Node Matrix for Havingness

| | | | | | En- | | | Modi- |
|---|---|---|---|---|---|---|---|---|
| Have | Be | Do | Have | Space | ergy | Time | Quanta | fier |
| Be | H-BB | H-BD | * | H-BS | H-BE | H-BT | H-BQ | H-BM |
| Do | — | H-DD | * | H-DS | H-DE | H-DT | H-DQ | H-DM |
| Have | — | — | * | * | * | * | * | * |
| Space | — | — | — | H-SS | H-SE | H-ST | H-SQ | H-SM |
| Energy | — | — | — | — | H-EE | H-ST | H-EQ | H-EM |
| Time | — | — | — | — | — | H-TT | H-TQ | H-TM |
| Quanta | — | — | — | — | — | — | H-QQ | H-QM |
| Modi- | — | — | — | — | — | — | — | H-MM |
| fier | | | | | | | | |

TABLE 3.4
Node to Link—Link Node Matrix for Space

| | | | | | | | | Modi- |
|---|---|---|---|---|---|---|---|---|
| Space | Be | Do | Have | Space | Energy | Time | Quanta | fier |
| Be | S-BB | S-BD | S-BH | * | S-BE | S-BT | S-BQ | S-BM |
| Do | — | S-DD | S-DH | * | S-DE | S-DT | S-DQ | S-DM |
| Have | — | — | S-HH | * | S-HE | S-HT | S-HQ | S-HM |
| Space | — | — | — | * | * | * | * | * |
| Energy | — | — | — | — | S-EE | S-ST | S-SQ | S-EM |
| Time | — | — | — | — | — | S-TT | S-TQ | S-TM |
| Quanta | — | — | — | — | — | — | S-QQ | S-QM |
| Modi- | — | — | — | — | — | — | — | S-MM |
| fier | | | | | | | | |

TABLE 3.5
Node to Link—Link Node Matrix for Energy

| | | | | | | | | Modi- |
|---|---|---|---|---|---|---|---|---|
| Energy | Be | Do | Have | Space | Energy | Time | Quanta | fier |
| Be | E-BB | E-BD | E-BH | E-BS | * | E-BT | E-BQ | E-BM |
| Do | — | E-DD | E-DH | E-DS | * | E-DT | E-DQ | E-DM |
| Have | — | — | E-HH | E-HS | * | E-HT | E-HQ | E-HM |
| Space | — | — | — | E-SS | * | E-ST | E-SQ | E-SM |
| Energy | — | — | — | — | * | * | * | * |
| Time | — | — | — | — | — | E-TT | E-TQ | E-TM |
| Quanta | — | — | — | — | — | — | E-QQ | E-QM |
| Modi- | — | — | — | — | — | — | — | E-MM |
| fier | | | | | | | | |

TABLE 3.6
Node to Link—Link Node Matrix for Time

| | | | | | | | | Modi- |
|---|---|---|---|---|---|---|---|---|
| Time | Be | Do | Have | Space | Energy | Time | Quanta | fier |
| Be | T-BB | T-BD | T-BH | T-BS | T-BE | * | T-BQ | T-BM |
| Do | — | T-DD | T-DH | T-DS | T-DE | * | T-DQ | T-DM |
| Have | — | — | T-HH | T-HS | T-HE | * | T-HQ | T-HM |
| Space | — | — | — | T-SS | T-SE | * | T-SQ | T-SM |
| Energy | — | — | — | — | T-EE | * | T-SQ | T-EM |
| Time | — | — | — | — | — | * | * | * |
| Quanta | — | — | — | — | — | — | T-QQ | T-QM |
| Modi- | — | — | — | — | — | — | — | T-MM |
| fier | | | | | | | | |

TABLE 3.7
Node to Link—Link Node Matrix for Quanta

| Quanta | Be | Do | Have | Space | Energy | Time | Quanta | Modifier |
|---|---|---|---|---|---|---|---|---|
| Be | Q-BB | Q-BD | Q-BH | Q-BS | Q-BE | Q-BT | * | Q-BM |
| Do | — | Q-DD | Q-DH | Q-DS | Q-DE | Q-DT | * | Q-DM |
| Have | — | — | Q-HH | Q-HS | Q-HE | Q-HT | * | Q-HM |
| Space | — | — | — | Q-SS | Q-SE | Q-ST | * | Q-SM |
| Energy | — | — | — | — | Q-EE | Q-ST | * | Q-EM |
| Time | — | — | — | — | — | Q-TT | * | Q-TM |
| Quanta | — | — | — | — | — | — | * | * |
| Modifier | — | — | — | — | — | — | — | Q-MM |

TABLE 3.8
Node to Link—Link Node Matrix for Modifiers

| Modifier | Be | Do | Have | Space | Energy | Time | Quanta | Modifier |
|---|---|---|---|---|---|---|---|---|
| Be | M-BB | M-BD | M-BH | M-BS | M-BE | M-BT | M-BQ | * |
| Do | — | M-DD | M-DH | M-DS | M-DE | M-DT | M-DQ | * |
| Have | — | — | M-HH | M-HS | M-HE | M-HT | M-HQ | * |
| Space | — | — | — | M-SS | M-SE | M-ST | M-SQ | * |
| Energy | — | — | — | — | M-EE | M-ST | M-SQ | * |
| Time | — | — | — | — | — | M-TT | M-TQ | * |
| Quanta | — | — | — | — | — | — | M-QQ | * |
| Modifier | — | — | — | — | — | — | — | * |

Note:
Asterisk (*) represents implied Flow 3 Link—Link Nodes which could exist but already do as other flow links.

As indicated by the asterisk, some of the possible Link-Link Node associations already exist in other Flow connections. It is unlikely that there is a need to have another connection to a link node to which one already exist, although this is not excluded.

This reduces the LLN count by the number of Nodes for each node set (as represented by any of the above tables).

TABLE 4.1
Item Counts

System
Element
Size

| | 6 | 8 |
|---|---|---|
| Nodes | 6 | 8 |
| Link Nodes | 21 | 36 |
| Link-Link | 90 | 224 |
| Nodes | | |
| Total | 117 | 268 |

Although this may seem like a large number, one must keep in mind that this is the entire limit necessary to run a system which essentially has no bounds. As large as this number may seem at first, it is still small compared to what it can do. For just a brief overview of a few capabilities, see the Examples section below.

Join Optimization

One of the issues with current database designs is their weakness to joins. Even the SQL language tends to dissuade anyone from attempting any complex joins. The trouble with that is that Joining data is the one thing which the universe does best—which also must be represented in any database wishing to consider itself capable of replicating the universe's capabilities or content. For this reason alone, it is highly recommended that this capability be optimized. Considering the fundamental simplicity of this model's design, there is no reason to consider that this couldn't be accomplished. Also, since is most database engines are essentially indexing data stored in various locations in a database's tablespace, there shouldn't be any reason why optimization couldn't occur when all element types and structures are defined and stable.

Queries

Syntax To simplify the reader's understanding of queries and focus on the objects of primary interest, this document uses symbolic additions to standard SQL syntax. The SQL language is rather limiting and certainly not optimized for the types of joins which this system requires and others which this model implies.

Element Notation

The elements themselves are identified by the first letter in their names as follows: B=Beingness, D=Doingness, H=Havingness, S=Space, E=Energy, T=Time, Q=Quanta, M=Modifier.

The data within the element is represented within parentheses in the order of data then data type. For example: B(Joe, person) or S(Los Angeles, city)

Applying this notation design to the Elements themselves we have some of the following notations.

| | |
|---|---|
| “x ≡ y” | (equivalent) This means where |
| | element x is linked to element y. |
| “x ⊂ y” | (subset) This means where an |
| | element x is a subset (or junior) to element y. |
| “x ⊃ y” | (superset) This means where |
| | element x is a superset (or senior) to |
| | element(s) y. |
| “x ∩ y” | (union) This means the combination |
| | of the linked elements x and y. |
| “x ∩” | (used with a single table) This means |
| | to “tunnel up” through element x. |
| | (See Flow Zero) |
| “x ∩ (4)” | This means to “tunnel up” four |
| | levels. This can be any integer value. |
| “x ∩!” | This means to “tunnel up” to |
| | the highest possible level - the top most level. |
| “x ∪ y” | (intersection) This means the intersection |
| | of the linked elements x and y. |
| “x ∪” | (used with a single table) This means |
| | to “tunnel down” through element |
| | x. (See Flow Zero) |
| “x ∪ (3)” | This means to “tunnel down” three |
| | levels. This can be any integer value. |
| “x ∪!” | This means to “tunnel down” to |
| | the lowest possible level - the bottom |
| | most level. |

Although the following SQL language or syntax has been provided for exemplary purposes above, it will be readily understood by those skilled in the art that other software codes or syntax could be used. For example XML code could be used to describe the nodes and data in the functions described above. Other languages, such as XQuery could also be used. In fact, since all languages are representations of the physical universe or concepts therein, and this model supports anything in the universe, it can support any language (machine, human or other).

Link Notation

Link Nodes are represented similar to Elements in that they are identified by the two elements which they connect. For example, a Beingness-Havingness Link node would be identified as “BH” or a Space-Time link node as “ST”. By convention the letter order is always in the same order as the Elements were first defined in this document.

Of course the data within a Link Node is different than that of an Element, so the parentheses would contain data specific to this relationship. This would include the Logical Relationship, as well as the association specifics in either direction from the Link Node such as an “employee” on one side with the “employer” on the other. Standard notation for a Link Node is to put within it's parenthesis anything which is defined within the Link Node itself.

Identities
“=” (equal) This symbol means that two datum or other link nodes represented on either side of this symbol are considered to be identical, one to the other.

Differences
“!” (exclamation) This symbol means that two datum or other link nodes represented on either side of this symbol are considered to be different one from the other.

Similarities

There are many ways something can be similar, these are the most common.
“˜” (tilde) This symbol means that two datum are similar to each other in an unspecified way.
“>” (greater than) This symbol means that two datum are similar to each other where the left datum is considered greater than the right datum
“<” (less than) This symbol means that two datum are similar to each other where the left datum is considered less than the right datum.
⊂” (subset) This symbol means that two datum are similar in that the left datum is a subset of the right datum. The left datum is considered junior to the right datum.
“⊃” (superset) This symbol means that two datum are similar in that the left datum is a superset of (or contains) the right datum. The left datum is considered senior to the right datum.
“∪” (union) This symbol means that two datum are similar in that the are both included in something common. This is the inclusion of both—and perhaps others—in a set.
“∩” (intersection) This symbol means that two datum are similar in that they represent an intersection of something.
[symbol] (any right arrow) This symbol represents a pointer to the next datum in a sequence.
[symbol] (any left arrow) This symbol represents a pointer to the previous datum in a sequence.
[symbol] (any up arrow) This symbol represents a pointer to the first datum in a sequence.
[symbol] (any down arrow) This symbol represents a pointer to the last datum in a sequence.

Once again, it will be appreciated by those skilled in the art that the notation could include additional symbols (as needed, or completely different symbols than those described above). These symbols and notations have been provided for exemplary purposes. Other examples which might be included could be “greater than or equal to”, “less than or equal to” or the like.

Further, the names of the Elements are used (in single character form—from the first letter of each Element Name) to indicate the applicable Element. And the datum within an Element uses the standard notation of being within parentheses as follows:
x(y) This means Element x containing datum y—where y is usually described in terms of the data & type. Where X is the first letter from one the above Element names.

This type of notation is extended to Link Nodes using the first letter of the Element name of each linked Element. For instance, a link between the Elements Be and Have would be represented as “BH”
x(y*z) This means the link node x containing the flow between element y and element z.

All Links are identified by the elements it links (e.g. A Be-to-Have link would be called “BH”). These links also contain attributes which are included inside parentheses after the link name. A reference includes several types of datum including:
The First Element's record ID
The Second Element's record ID
The First Element's relationship to the Second Element
The First Element's relationship type
The Logical Relationships symbol
The Second Element's relationship to the First Element
The Second Element's relationship type.

The reference to any of these within the parentheses is as determined by the need for the reference while the record ID's are implied—as one cannot link without some way to relate the records. Where a reference is not needed, it should be identified (e.g. “BH(rel1,type1,<,type2,rel2)” can become “BH(rel1,,<,,rel2)”) It is not within the scope of this document to define the order of these reference elements nor the requirement for comma separation or parsing. To simplify, we'll only use this link as a three-parameter link herein.

A Link node is shown as linked using the mathematical equivalence symbol (“≡”—three horizontal bars) where the Element preceding this link is considered the “first” element and the one succeeding the link is considered the “second” element as in the following example:
B(“Joe”,person)≡BB(employee, ⊂,employer)≡B(“ABC”,company)

Link-Link Nodes

As defined earlier, a Link-Link Node is a Link Node which connects a Node to a Link Node via another Link Node. This is the technical form of Flow 3 linkage as represented in FIG. 7C. The connection itself is Logically represented in FIG. 3B as 90099—which literally means “Node 9 (generic node) connected to Link Node 99 (generic link node)”.

An example of common usage might be to link a Time to when a person (Be) was in a particular location (Space). For this we'd represent the Link-Link Node as “T-BS( )” where the parameters inside the parentheses would further describe the relationship of interest (the same as for any Link Node).

Since a Link-Link Node is simply a Link Node attaching a Node to a Link Node just as one might do between two Nodes, the syntax (other than the link-link node name) would be the same as for any other Link Node.

Samples Queries

An ordinary query might be something like the following:

```
Flow 1: List all the cities our trucks are in.
              Space  Be
Flow 2: List all of our trucks in Seattle.
                    Be  Space
```

Assuming that the “trucks” are “our”, from the above could come queries which looked something like this:

F1:

SELECT S(city) FROM Space, Be
WHERE S(city) ≡B(truck);

F2:

SELECT B(truck FROM Be, Space
WHERE B(truck) ≡ S(city)
AND S(city) = “Seattle”;

Using our more compact syntax for this last query it might look something like this:

SELECT B(,truck) FROM Space, Be
WHERE B(,truck) ≡ S(“Seattle”,city);

Note that the symbol is the “equivalence” symbol and not the equal sign. As mentioned above, this is a notation that these two tables are linked based upon the data supplied. If we so chose, we could just as well have limited the link to a specific logic or relationship by interposing the link node into the reference.

Of course, while these scripts at least appear familiar to those who know SQL, some of the language rules are rather redundant and unnecessary with the new syntax. For instance, in the last query above we notice that the need to define the FROM tables becomes a repeat of what we already know, since B( ) and S( ) already tell us this. So the language could be reduced to:

SELECT B(,truck)
WHERE B(,truck) ≡ S(“Seattle”,city);

Or even further to:

SELECT B(,truck)
WHERE ≡ S(“Seattle”,city);

Which tells us everything we need to know about this query. Of course, where one is retrieving data from multiple sources, one might want to use more inclusive script.

Flow 0 and Tunneling

If in some earlier examples we wanted to create a list of trucks we owned and “our company” was “ABC”, this would become a Flow Zero operation (Be to Be relationship). One might do the following:

List all the trucks owned by ABC company
Be Be

F0: (Flow Zero)

SELECT B(,truck)
WHERE ≡ BB(“asset”⊂ “owner”) ≡ B(“ABC”,company);

Other examples might be:

| List all employees of company ABC | |
|---|---|
| Be | Be |
| List all the steps required to bake a cake | |
| Do | Do |

The first becomes something like:

SELECT B(,person)
WHERE ≡ BB(employee, ⊂, employer) ≡ B(“ABC”,company);

And the second as:

SELECT D(,step)
WHERE ≡ DD(step, ⊂, action) ≡ D(“Bake a cake”,action);

“Tunneling” is simply an invented name for a method of looping through data through these elements. An example for a single node tunnel might be a box inside a box inside a box, where one could “tunnel” down using Flow 0 until one found the item one was looking for. It doesn't matter how far down it is, but more that one can get down to it. One can also “tunnel” up—like to a parent, grandparent, etc, etc.

Some of the syntax developed above was designed specifically for tunneling, where one would list the element and datum one is interested in with the symbol notation representing a priority towards a junior or senior typed element.

Who is the oldest relative I have?

Since all the data of a given type is in a single node, there's no reason one can't simply locate the record of interest and look for the connections between that an the one's you already have.

Flow 3 and Data Mining

It became evident that there was a requirement to be able to connect to a link node or other than simple linking. This flow, “others to others” as shown in FIG. 7C, resulted in the addition of physical links necessary to support this flow, namely, another link node connecting any node to any of the existing Flow 1, 2 or 0 Link Nodes. The interconnections are illustrated for the Primary Elements in FIGS. 8A-8D and for the 8-Element system in FIGS. 13A-13E. Such flow is represented in the following query statement:

When was someone a member of a group?
Time Be Be

For example:

When was Joe an employee of XYZ Lumber?
Time Be1 Be2

Which can be represented mathematically as:
T=B1⊂B2

Current SQL would look like this: (making assumptions about the table fields for the sake of this example, as well as making allowances for syntax in order to simplify the expressions)

SELECT T.* FROM Time AS T, Be AS B1, Be AS B2, BB, T-BB
WHERE B1.name = “Joe”
AND B1.type = “person”
AND BB.BeID1 = B1.ID
AND BB.B1type = “employee”
AND BB.Assoc = “⊂”
AND BB.B2type = “employer”
AND BB.BeID2 = B2.ID
AND B2.name = “XYZ Lumber”
AND B2.type = “company”
AND T-BB.BBID = BB.ID
AND T.ID ≡ T-BB.TimeID;

Obviously this is quite a long statement for what would seem like a simple request. The simplified SQL would look like this:

SELECT T( ) FROM Time, Be AS B1, Be AS B2
WHERE B1(“Joe”,person) ≡ BB(“employee”, +532,”employer”) ≡
B2(“XYZ Lumber”, company)
AND T ≡ T-BB(“employee”,”employer”);

Or if we didn't care which relationship he had with the company (employee, customer, etc) then we could get away with something like this:

SELECT T( ) FROM T-BB, Be AS B1, Be AS B2
WHERE B1 (“Joe”,person) ⊂ B2(“XYZ Lumber”,company);

In this instance the relationship between the two Be records is established and an implied BB relationship, and the Time is implied from the T-BB usage. Of course for more complex queries or those in which the link node being viewed from flow 3 (in this example BB) might include Time as one of the nodes, then one might want to be more explicit in their defined relationships.

It is interesting that we can write the query as a mathematical equation just as we might any other math formula. It is this advantage which lends itself to probable advances in query languages themselves.

Data Structure Examples

Any type of data structure can be created using the model of the present invention.

Linked Lists (Single/Double)

Linked Lists are simply chains of data attached together in an order. Of course any element can be attached to any other element, but a list is usually chained with one prior item and one later item.

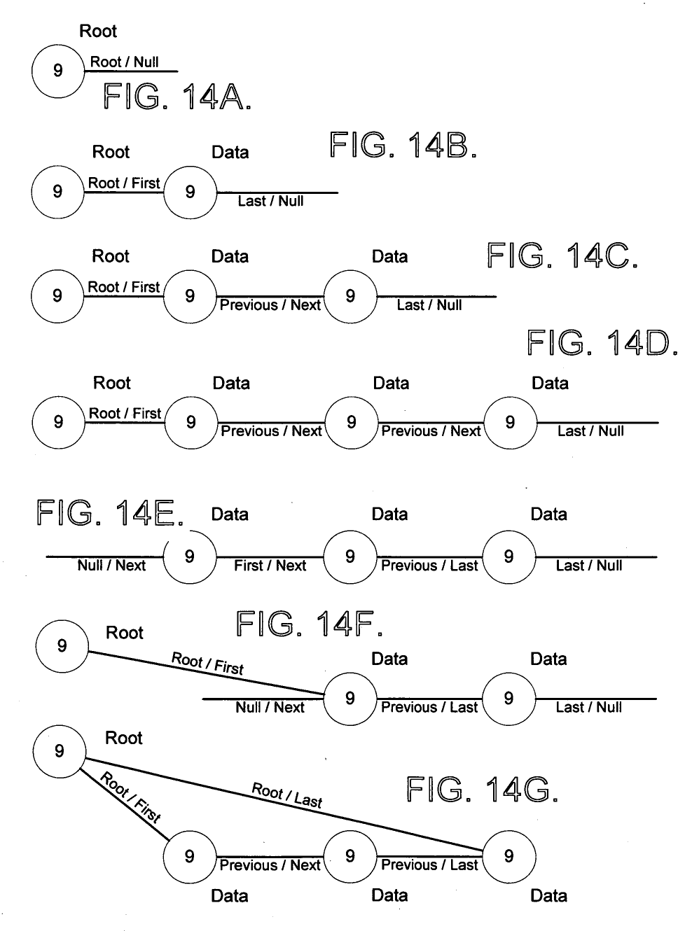

As shown in FIGS. 14A-14G there are any number of ways a list may be created, but they always start with what is called a “Root”. A Root is simply one data item which is used to represent the list as a whole. It is usually attached to the list of data or the list data is attached to it. In this model the attachment would natively be two-way.

The data chain itself could be terminated at the ends of the chain either by a data element with no previous or next data element or link reference (as shown in FIG. 14G), or it could include the be attached to a “hanging” Link Node (a Link Node attached only to one Element) in which case the unattached end could be considered the end-of-list just as “null” values are typically used in current pointer structures (having to fill a “next” or “previous” field for which there is no data). This applies for any of the other data structures.

Queues (FIFO)

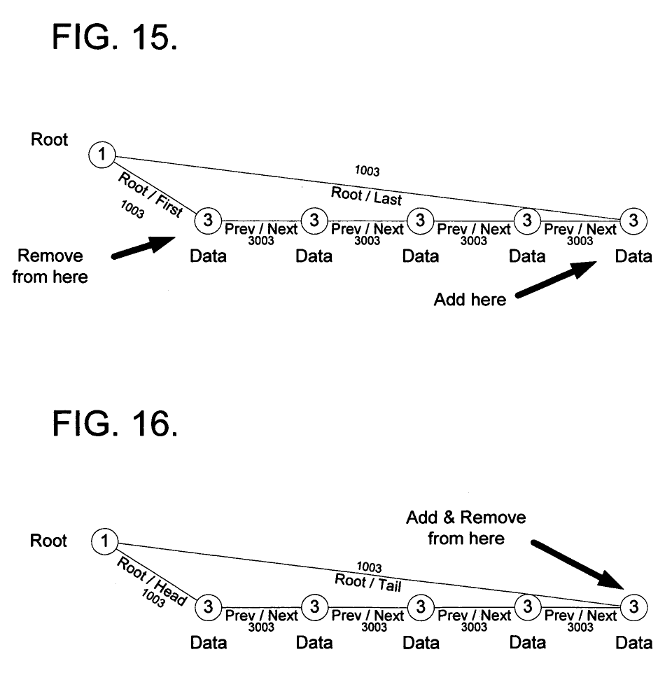

A Queue (as represented in FIG. 15) is simply a list where data is added to one end of a list and removed from the other end. This is also called a “FIFO” which means “First In, First Out”. A FIFO list (such as a line of people waiting to purchase something) requires simply that we know the first and last nodes and add data to the last while removing it from the first. This is easily accomplished using structures from the above Double-Linked List (using one Node as a Root Node). The first datum is added to the node and everything else is attached to that datum. When the datum is removed, the pointers are re-linked to the next element in the list. This is standard data technology.

Stacks (F LO)

A Stack (as represented in FIG. 16) is simply a list where data is added to one end of a list and removed from the same end. This is also called a “FILO” which means “First In, Last Out”. A FILO list (such as a stack of boxes where the ones on top must be removed before the bottom one) requires simply that we know the first and last nodes and add or remove data from the last one in the list. All pointers are adjusted to maintain this relationship. This is standard data technology.

B-Trees

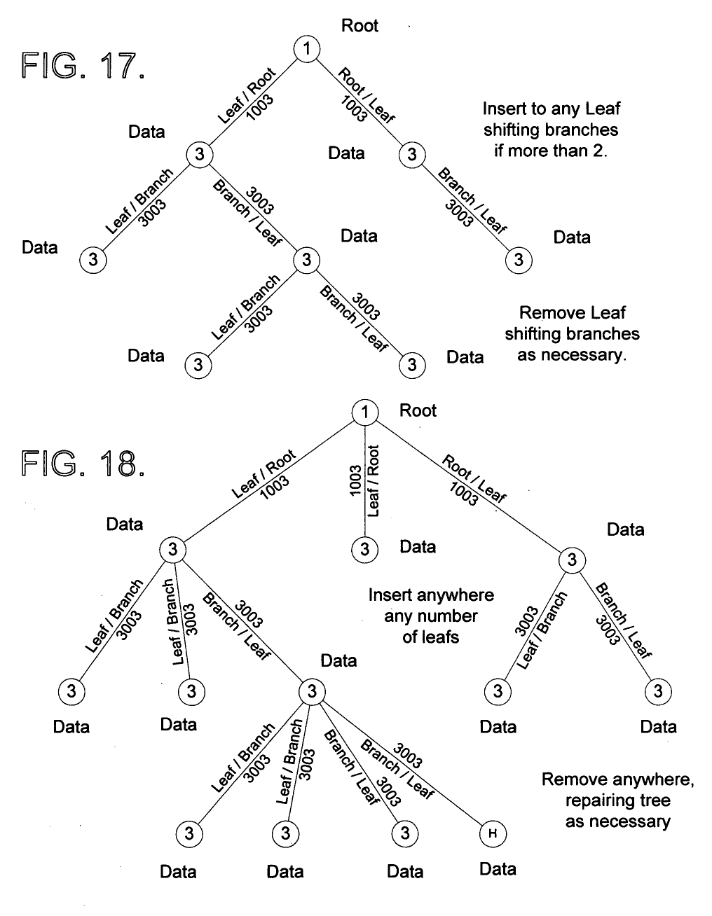

A B-Tree (as represented in FIG. 17) is a data structure whereby data is attached to a single node with no more than two “branches” from each node. If there are more than two nodes, then the extra ones get attached to any attached node branching off in pairs until the entire “tree” is populated. This is a popular structure for searches and sorting data because it limits the number of steps down to the farthest branch. This can easily be created by the present invention and is a standard data technology.

Heaps

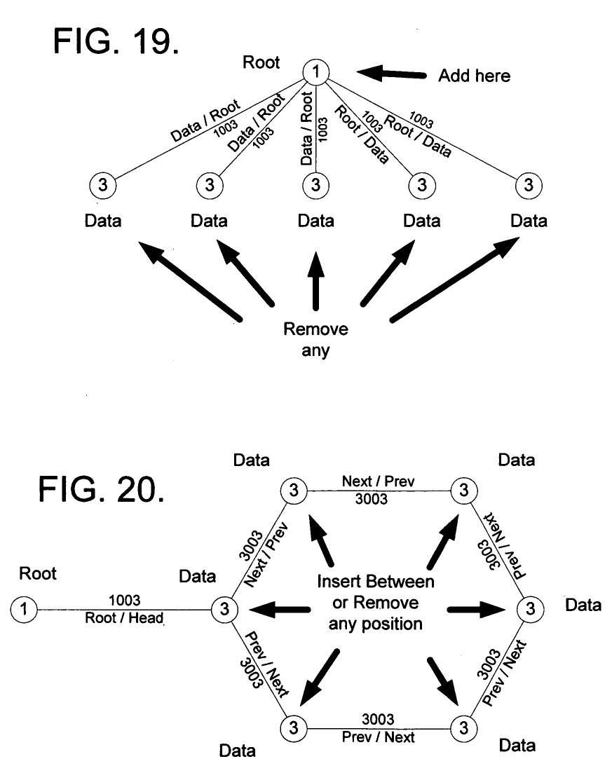

With reference to FIG. 19, a Heap (which could also include a “Random Tree”) is a structure in which data is added, modified or deleted in any fashion the user may desire. These usually have little order except to monitor the total capacity of the system and the referencing of the resources. An example of a random tree is represented in FIG. 18. This can easily be created by the present invention and is a standard data technology.

Rings

A Ringed List (as represented in FIG. 20) is a circular list with no beginning and no end other than a Root. It uses a Root Node as a starting and ending point of a linked list where the root may be part of the loop or stand outside the loop (as illustrated in the diagram). This type of structure could easily be created by the present invention simply by linking a list to itself and attaching a one node as a root to be inside or outside the ring. This is standard data technology.

Hash Tables & Dictionaries

A Hash Table is a list of data usually organized alphabetically from whatever data happens to some in. Using a group of people and taking their names one would add the name in the list where it fit until one had a complete list of all the people in the room. It makes no attempt to create any other type of indexing other than the native list created by the data provided. Of course, for the invention, this is as simple as an ordinary linked list structure—inserting data where it fits. This is standard data technology.

Other Structures

Of course there are many other possible data structures, such as the one shown in FIG. 18 which is essentially a random tree with any type of data attached to many links branching out from a root node. This is standard data technology.

Applications (by Element)

Be

Genealogy

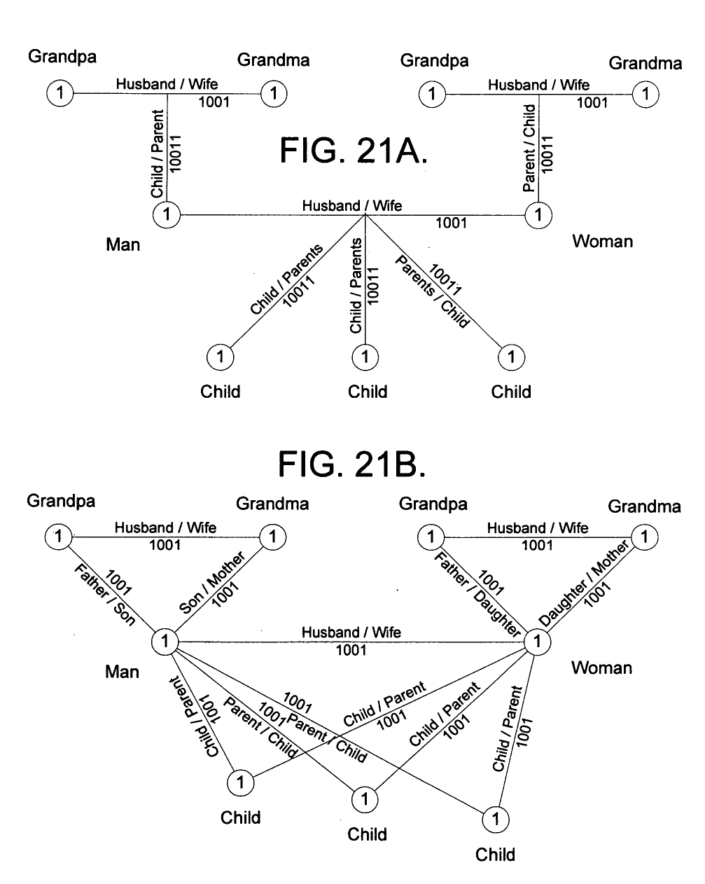

As illustrated in the example of FIGS. 21A and 21B, all types of personal relationships can be created including the example of genealogy. However, while this database model can prevent problems associated with flawed or inadequate database schemas and associated problems, there is no way to prevent a user from creating incorrect associations. In this example a user might want to create a hierarchy of related people and attempt to link children to the link between the two parents. This would result in an incorrect data design as it would not be possible to easily climb or descend such a tree between a child to a parent without having to go through an arbitrary association such as a marriage which may never have existed. And in order to reach a parent, one would have to go through this relationship and find the parent node from that. This is inefficient and illogical in terms of stored data and relationships.

A more correct version would be that represented in FIG. 21B where each child is directly associated to each of his/her parents and the parents to each other. This would make ascending and descending such a tree as simple as looking up a parent and then the next parent as far up or down as one cared to search.

In a proper genealogy system, one would be able to tunnel up or down any number of degrees until one had the complete list. Tunneling is a technology introduced and suggested in this invention.

The fact is, that despite the capabilities of this model, it is only as good as the data provided. It still requires some logical data set up with true & correct relationships.

A Person

With reference to FIGS. 22A and 22B, another example of correct and incorrect data application comes in the typical definition of a person. Typically people are identified as their name. So what happens when they change their name? An event which happens? Or what if they changed any other attribute which one might base an identity upon? It would create a problem, and is an incorrect usage or identity of a person.

A Being is an entity. A name is an identity, and one might change their name so it would be a poor method of identifying someone. Also, in a crime investigation we might be interested in collecting information on the criminal without knowing who it was. This generic Beingness would be linked to all the evidence found so far. And where the database found a match it would now be able to supply a name.

To more properly model a person one would have to separate the person from all their attributes as simply the person themselves. After that they are attached with names and any other type of attribute.

This is particularly useful for police work where the only thing known is that and unidentified someone did something. This would be a “person” record linked to the activity and every other piece of evidence until one were able to match this person to a name or other key identity element.

As illustrated in FIG. 22B, it is common that people share the same names with other people. A truly universal database wouldn't waste space by storing the same data twice but should instead link each person to the common data elements. In this way one could also do queries on such data to find all the people associated with a particular attribute. It makes searching easier.

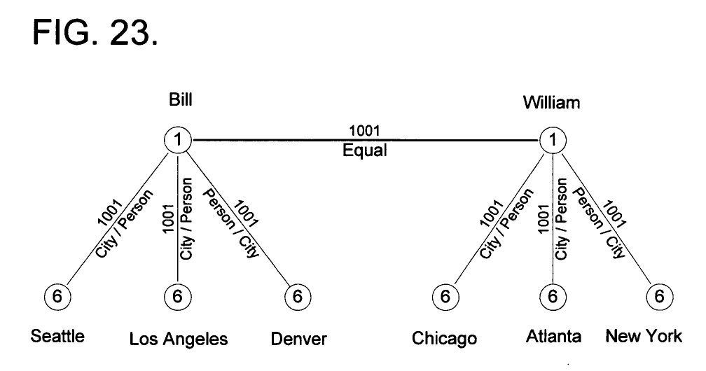

Identities is perhaps another very powerful element in this data model which is absent in other designs. With reference to FIG. 23, let's say that one person visited Seattle and Atlanta, and another person is known to have visited New York and Los Angeles. And later we discover that the two persons are the same person. This creates an “Identical” relationship between these two records and if one were to query about one person, the system should be able to recognize these identities and apply the queries along all identities also. This doesn't just apply for Beingness as it can apply for any other Element. A Being is not necessarily a name, and because this database doesn't store duplicate data, many beings can be attached to the same name—as it is in real life.

An Identity

Ignoring the fact that one shouldn't use name as the core identity of a person (as mentioned above), imagine that we have two people who have been traveling to various cities as illustrated by FIG. 23. One fellow named “Bill” and the other named “William”. Bill has visited Seattle, Los Angeles and Denver while William has been to Chicago, Atlanta and New York.

Now let's say that it is discovered that Bill is really just a nickname of William and that the two people are really the same person. This would create an equality between the two records using the “Identity” relationship mentioned in this document.

With this done, all future references to William should also reference to his “equalities” (the identity “Bill”) and visa versa. In other words, these would be treated as if they were records of the same individual—which they essentially are. Current database system don't do this, but this equality could exist not just as an identity but also for any other element type and could be used widely.

Do

A Sequence of Steps

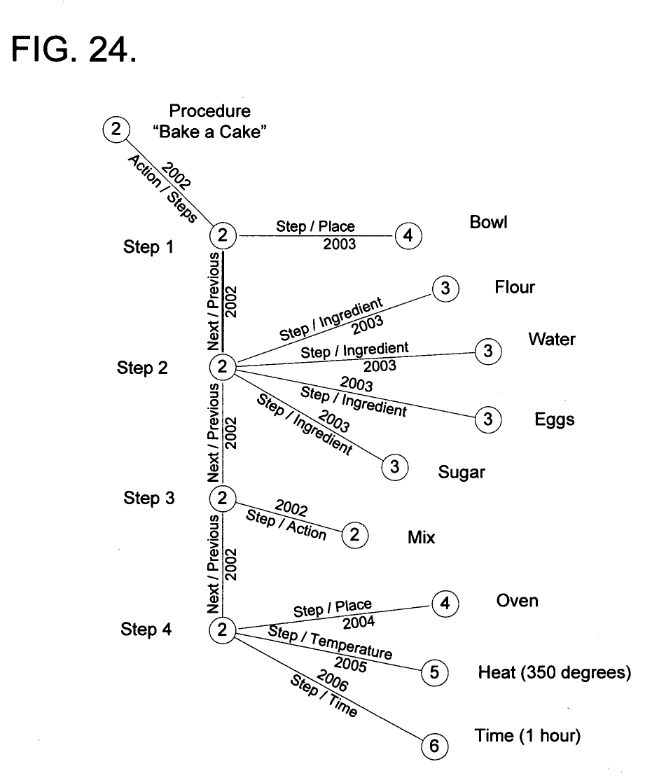

A Doingness generally has man doingnesses with it. One action can require many steps to complete. So Doingness is another hierarchy to climb just as Beingness was for Genealogy. A step might be a single instruction on how to build or make something, as illustrated in FIG. 24.

The Olympics

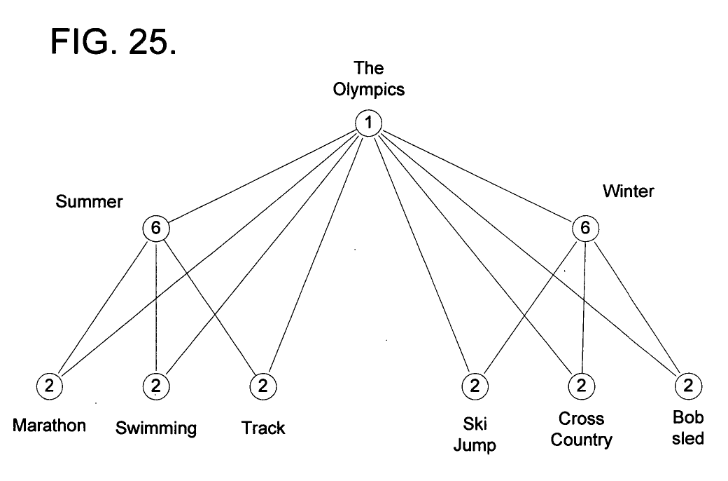

The Olympics is an action which includes Summer and Winter sports. It also includes many sub-actions we call events on down to a single race. This is a hierarchy, as illustrated in FIG. 25.

Employment

One should take care in defining a Beingness to be something which is actually a Doingness. In employment, it is usually the Doingness which defines what you are. If you write a book, you are a writer. If you produce a movie, you're a producer.

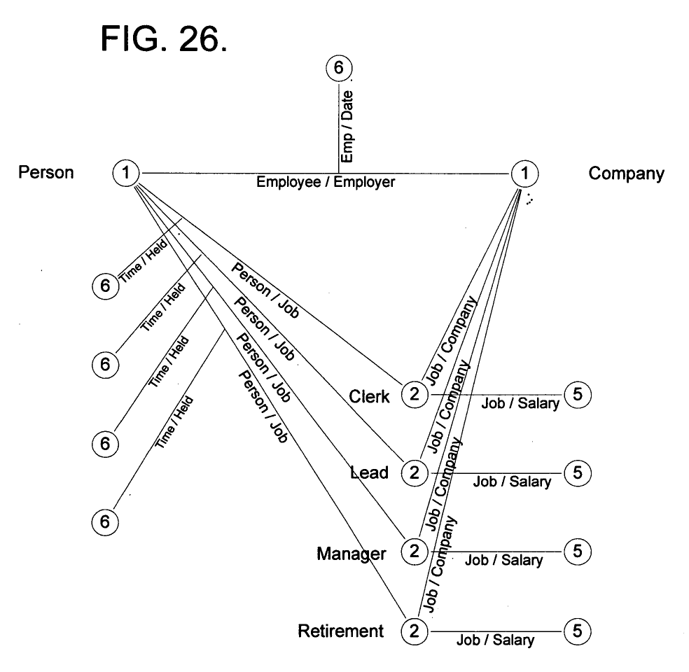

In FIG. 26, we have a Person and a Company in association. The company has a number of Jobs which each have different salaries. This person linked himself to the company in a relationship called “employment” on a certain date. He also held a number of jobs over the years before he retired. Of course although his “employment” relationship with that company came to an end, he still is associated with that company through a new relationship of the retirement—which has its own “salary”.

Have

Inventory

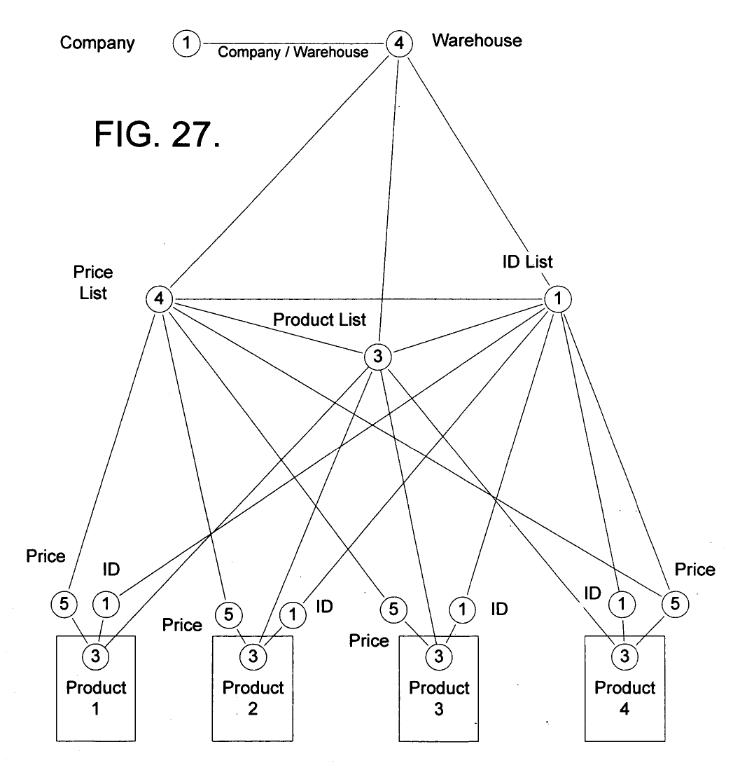

An inventory of your property would be a listing here of your Havingnesses. Cars, House, Stocks, etc. Or even the warehouse inventory, as illustrated in FIG. 27, with the considerations of the company, warehouse, price list, I.D. list, product list, prices, and products. In the illustration, the products are indexed both by identity and a price and so can be looked up by either reference. There are many other business relationships one might want to know about an inventory, including archival data.

Paperless Office System

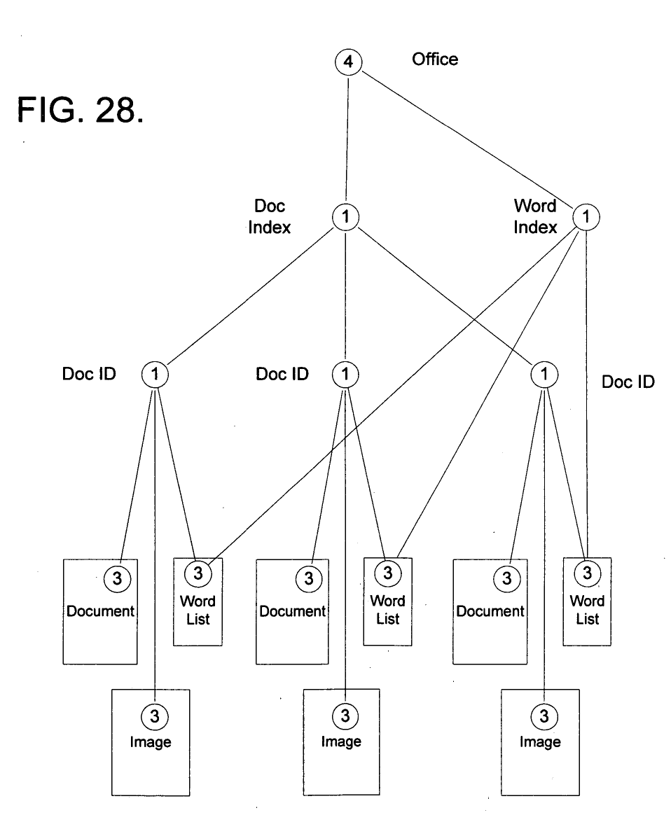

A file might be a document (as a Word file), the scanned image of a document (as an Image file), the text of the document (as any type of text file), etc. Including any Audio or Video or other media references. In other words, we could easily create a paperless office system with this database alone. An example of a paperless office using the present invention is shown in FIG. 28, with the office consisting of Word and Document indexes, document identifications, documents, word lists and images, all stored in the various nodes and link nodes for retrieval and association.

Of course, it should be apparent that a paperless office system looks quite similar to a warehouse, the primary difference being that one is storing documents rather than products and interested in words than prices or product descriptions. Otherwise they can be handled quite similarly in many other ways.

File System

Any File System is simply a method of organizing data. In the case of computer file system (such as on a hard drive), it is a simple data structure used to organize the data on a hard drive for rapid searches and retrievals. Since this invention can model any type of data structure, and the structures used to store data for any computer operating system are pretty standard and basic, these too can be replicated by the invention. In fact, using the invention model for the organization of file data on a hard drive, instead of using a typical tree view of directories where a file could be only in one view, it would be possible to locate a file in any number of views which match the attributes of that file. For instance, a photo of a friend could be filed in a directory called “Friends” as easily as it could the city or any other attribute associated with that friend.

Also, from another perspective, it is also possible to incorporate the database model into the underlying system typically called a “cluster” because the space representing a Block on a hard drive could just as easily be mapped to a space element representing a “cluster” or a “file” or any other file system element.

References aren't limited to local files as we might also want to reference internet files (such as HTML pages or their URLs).

Further, device access could go all the way down to he hardware or file system where the Hard Drive (Drive C:) is the reference or a certain block or directory on that hard drive.

In fact, the idea of a non-tree directory system is particularly favorable. Two directories stored in this system might point to the same file (a Picture under the directory “City” and another link by the directory “Friends”). Perhaps even by date or anything else you want to use to link something to the physical data.

Despite the fact that database models have long since moved away from Hierarchical Models, even today, something as common as file systems and directories have not. Using this invention, this could be made just as robust as any other type of indexing or search system.

Perceptions

A perception is simply an input from the environment. Technically all computer interaction with the outside world goes through the Element of Havingness—from input to output. One uses this as the storage of the vast quantities of data acquired while the remainder of the database model represents the intelligent processing of the data so acquired.

In fact, this model makes a very good storage model even resembling something as complex as human memory and some aspects of the mind. And as a command line out to the world, Havingness is the ideal channel.

As an interface, it is the link to controlling the outside world. This might include certain device drivers referenced and passed certain parameters (from other Element definitions) to execute the operation. Perhaps it is the robotics command to move something to a physical location referenced by a Space link.

In the case of robotics where one had an interest to have a more intelligent robot as well as be able to store perception history data in a useful form, this invention certainly can do this. While one might receive an image in, the only things we might be interested in this image (after it is processed) are the coordinates of certain identities (Be) as well as when (Time) they were in those locations (Space). Of course any of the rest of the Elements do apply, as one might also be interested in tracking the motions (Energy, Do). Adding arbitrary descriptions to this would also include the Quanta and Modifier elements.

Havingness is the input from the outside world. Until processed it is most certainly just raw data—unanalyzed into the component Elements (of this database model). When analyzed it is interpreted in terms of all the other elements of this system.

Space

Shipping

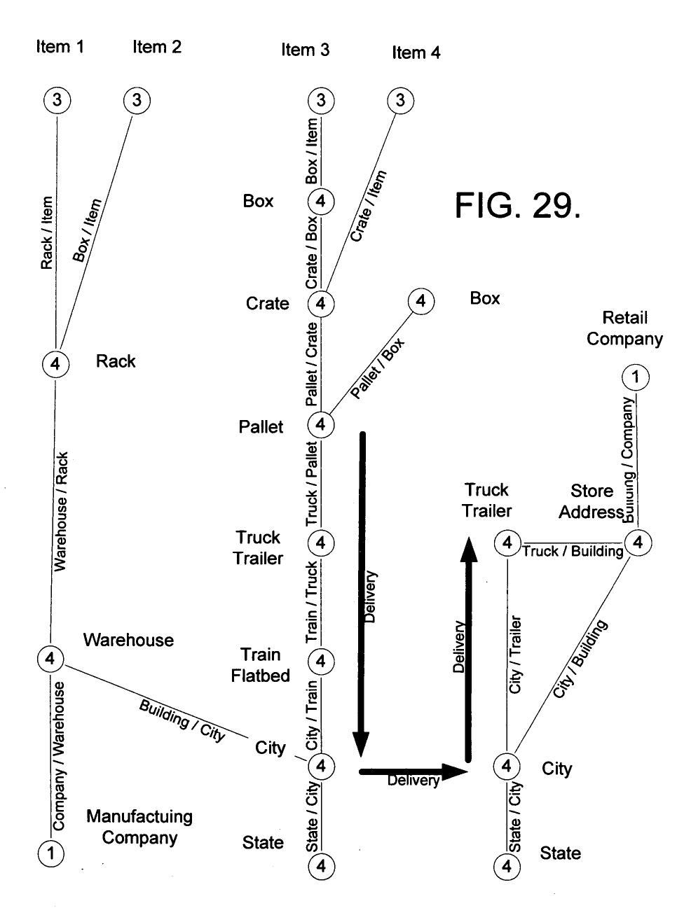

As far as application, we might consider the spaces themselves. A box in a warehouse might have an ID (Beingness as a bar code or label) but it also has a physical space associate to it. And that space might include something inside it (such as a Havingness). It might also be that this box is inside another larger box (with it's own space definitions and beingness). Move around, this box can be included with or in any number of other boxes. Be on a pallet, in a truck on a train in a city in a state in a country, etc., as illustrated in FIG. 29. The Space-to-Space flow zero reference can be very powerful for certain activities.

In FIG. 29 we wee that a warehouse company has a couple items in inventory and has shipped two other items to a retail store. This shows the complete stacking of all spaces associated with those items.

One of the most complex of all warehouse issues to solve was that of being able to “split” a pallet—to take some things from one pallet and move them to another. It was even more complex when you have to track everything which was contained in those moved boxes. But if you look at the way the present invention is set up, it would be as simple to move a box containing 1000 items (and sub-boxes) as it would a single item. And one need only find where the delivery vehicle was in order to know where any one it's contents were. One could use a truck to track it's contents, or any content to track the truck. They tie neatly together in a most useful way.

Energy

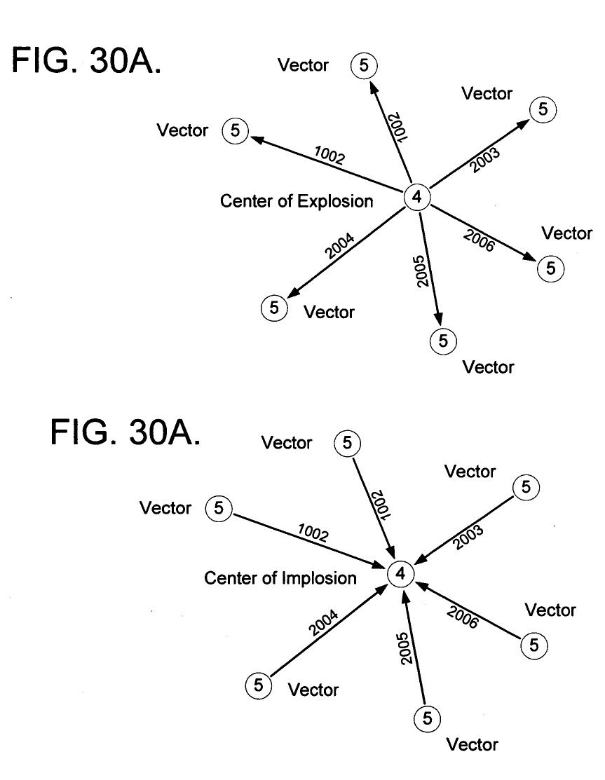

Force is vectored energy. It might be a Flow, Dispersal or a Ridge. When kinetic as a flow, one might express an explosion as the dispersal of forces from a common point, as illustrated in FIG. 30A. In other words all vectors would diverge from the common point (which can further be defined as a space). Implosions are simply the convergence of these flows, as shown in FIG. 30B.

Money & Accounting

It is important to note that Energy is not defined strictly as itself but also it's various forms. For instance, money is a form of energy—a solidified forms. One works a week (doingness using energy) which is converted to a solidified, unflowing form we call money. Thus all accounting easily fits in here.

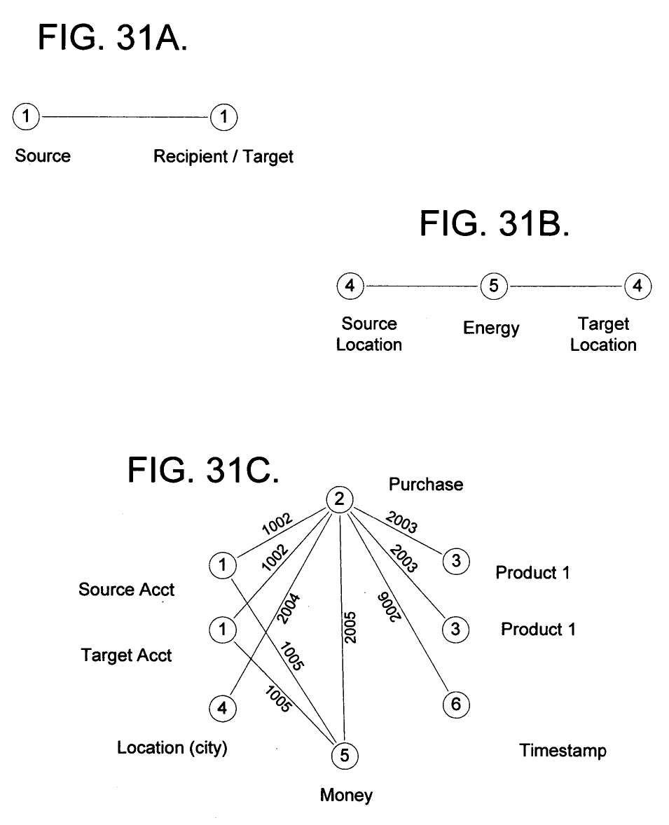

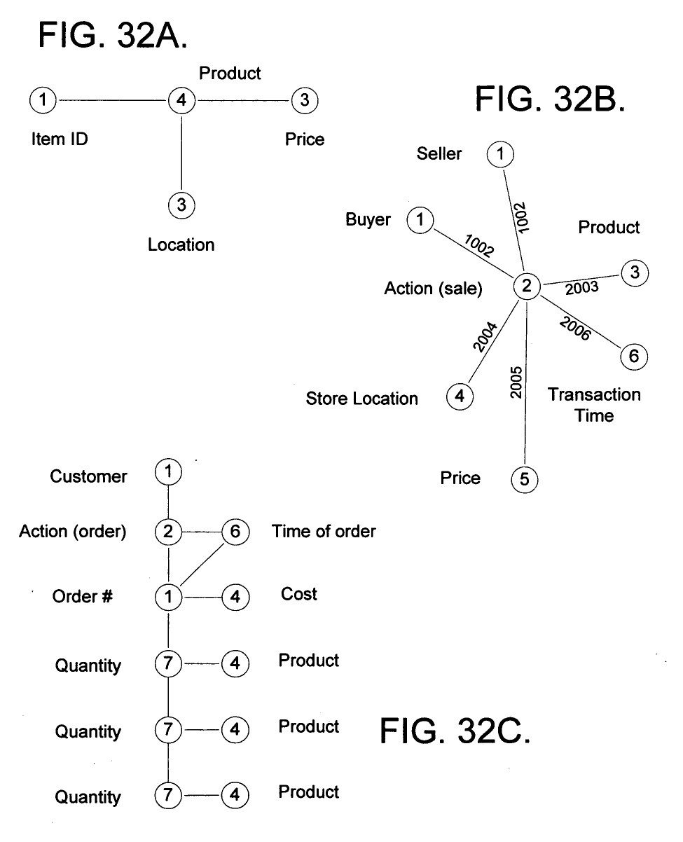

Energy flows from one place to another. By utilizing “from” and “to” (in whatever structural form it may be), one could also show the flow of funds from one account to another, as shown in FIGS. 31A-31C, which illustrate simple examples of basic accounting structures.

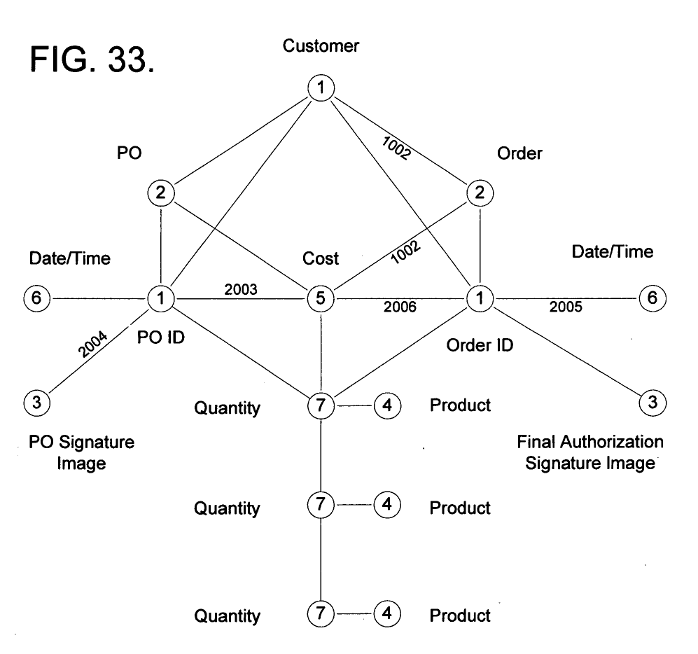

Orders, Invoices, Purchase Orders and Purchases are simply flows or potential flows. These can easily be represented by this invention in terms of data alone. An example of a PO being converted to an Order can be seen in FIG. 33, where the PO is on the left and the Order attachments are on the right side of the diagram.

Time

Batch Processing

Batch Processing is simply definition of an Activity (Doingness) applied at an indicated Time. Where the Doingness is a list of actions to perform, we're improving Batch Operations almost up to the level of complex automation.

Automation & Programming

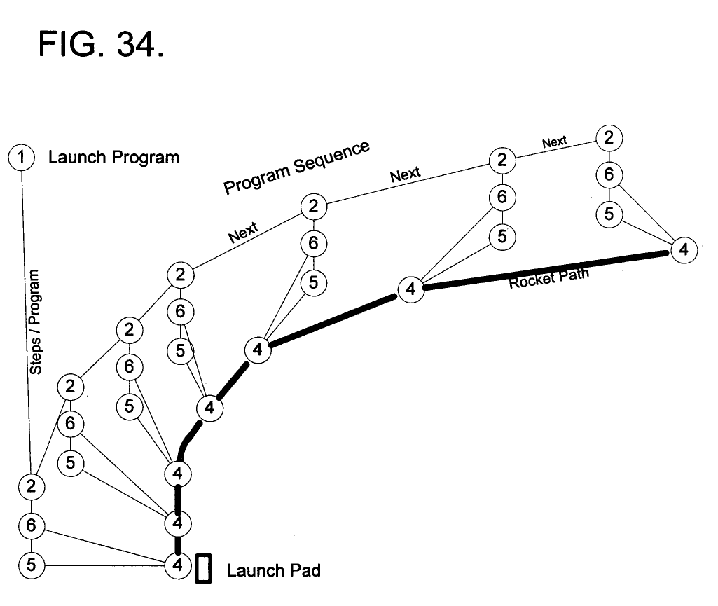

Automation is simply the definition of certain events in time. Some of these include Space and Energy. For a Rocket, as illustrated in FIG. 34, we might provide a list of certain desired times to be at certain Spaces with certain velocities (Energy). The rocket guidance system would control the rocket to meet those rules as the timer clicked on. Current rocket guidance systems work on rules such as these, in this case it would just be programmable from the same database system as any other hardware in the market. In FIG. 34, the line 210001 represents the Launch Pad Tower and the line 210002 represents the flight path of the spacecraft.

For instance:

| | | SPACE | | |
|---|---|---|---|---|
| | TIME | (altitude | (range | ENERGY |
| DO: Event | (min:sec) | feet) | miles) | (velocity mph) |
| Countdown | | | | |
| Launch | 0:00 | 0 | 0 | 0 |
| Clear Tower | 0:15 | 150 | 0 | 200 |
| Roll Program | 0:30 | 1,000 | 0 | 400 |
| Pre-MaxQ Throttle Back | 1:00 | 35,000 | 6 | 2,000 |
| Post-MaxQ Throttle Up | 1:15 | 52,800 | 10 | 4,000 |
| Staging 1 | 4:00 | — | 100 | 10,000 |
| Staging 2 | 9:00 | — | 200 | 12,500 |
| Main Engines Cut-Off | 12:00 | — | 350 | 17,000 |

Manufacturing

Ordinary manufacturing consists of certain Doingness in space, with energy applied at certain times. In other words, it is all time driven. A robotic arm welding an automobile body can be programmed to execute the action (DO) of “Weld 1” at a particular Time which would consist of moving a robotic arm (HAVE) to a particular location (using SPACE and ENERGY) and when these conditions are satisfied, an electric arc (ENERGY) is applied to weld the car body.

Any type of conveyor system is more of the same. Essentially all automated manufacturing can be defined from this operations.

Quanta

Constants, Variables & Equations

Most databases just store constants. Obviously these are the most vital to any data system. And yet the world consists of things which are anything but constant. These, stored as variables or even equations, may be used to represent an ever changing world. Some simple forms of a Quanta can be seen in FIGS. 13A-D.

Uses for Variables may be where the value of something is unknown. Certainly a placeholder could be used to represent the unknown value and the results might be computed down to this unknown.

Further, if the unknown variable was not just a variable but defined as part of an equation then one could use this to determine the value based upon other inputs. This makes this field even more dynamic.

Expanding this, one might make chains of equations which pass through common variables such as:
F=M*A
A=V*T

Where A is in common to the two equations. In this case, should one solve one of the equations (at least to determining the value of A), one might be able to solve the other with greater ease.

Computing machines could be programmed with all known equations and programs developed to help derive even more answers from any collection of inputs. This could potentially be a mathematical knowledge base whereby inputs of any portion of the equation can be used to solve to an output at other ends.

Functions

A function is a special case in Quanta. In fact it is what makes spreadsheets so robust—the fact that one can define and compute using re-usable tools. Such functions might include the computation of Sines, Cosines, Tangents and plenty of others. Just as one applied equations above to the design and development of intelligent computing systems, so too would these increase the robustness of such a system.

Modifier

Personal Attributes

A modifier is used to define the attributes of something. If we were investigating a crime scene (as described in Beingness above) we'd be collecting things which included descriptions of someone (white, male, blue eyes, brown hair, etc). From a large enough collection of common data one might be able to isolate and eventually locate the fugitive.

For the most part this could be considered an adjective (Beingness, Havingness, Space, Energy, Time) but for Doingness it is called an adverb. (It's simply English semantics). One ties common modifiers to Elements, reusing the Modifier as well as making the Modifier itself a searchable element.

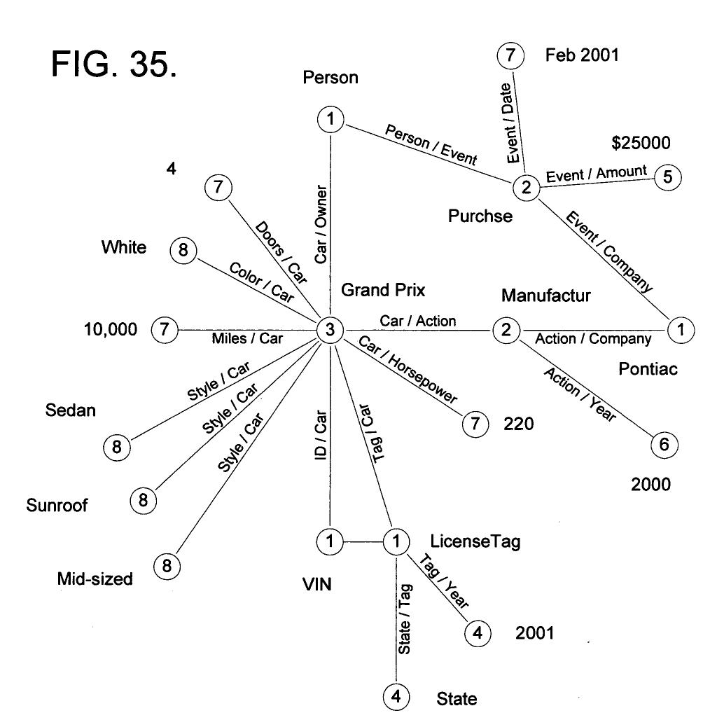

Other examples might include descriptive references such as that represented in FIG. 35 of an automobile. The car itself is described in terms of a Havingness further described by any number of attributes one calls styles, make, model, color, etc. There might be many potential attributes and relationships which might be associated with an automobile.

Sentence Parsing & Translations.

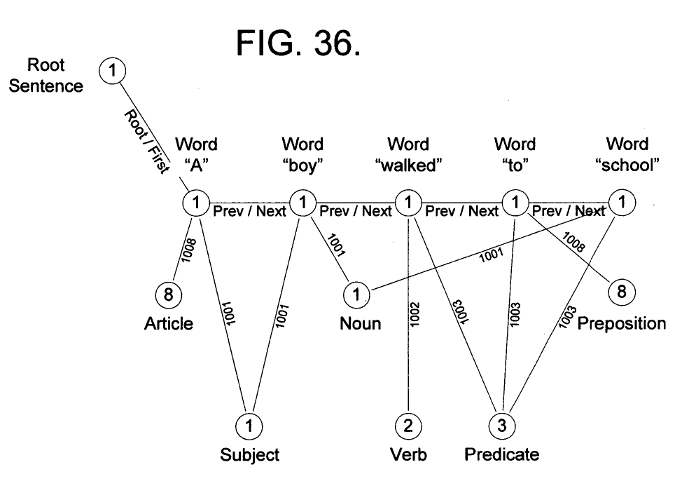

With reference to FIG. 36, the Grammatik components of any sentence can be defined in descriptive terms we call Modifiers. While the words of a sentence may be identities (essentially identities representing something in the physical universe), the words themselves can be further described by what we call grammar.

Essentially, when the components of a sentence have been identified, the identities (the words themselves) can be replaced and the sentence reconstructed using the grammatical rules applicable for the new language.

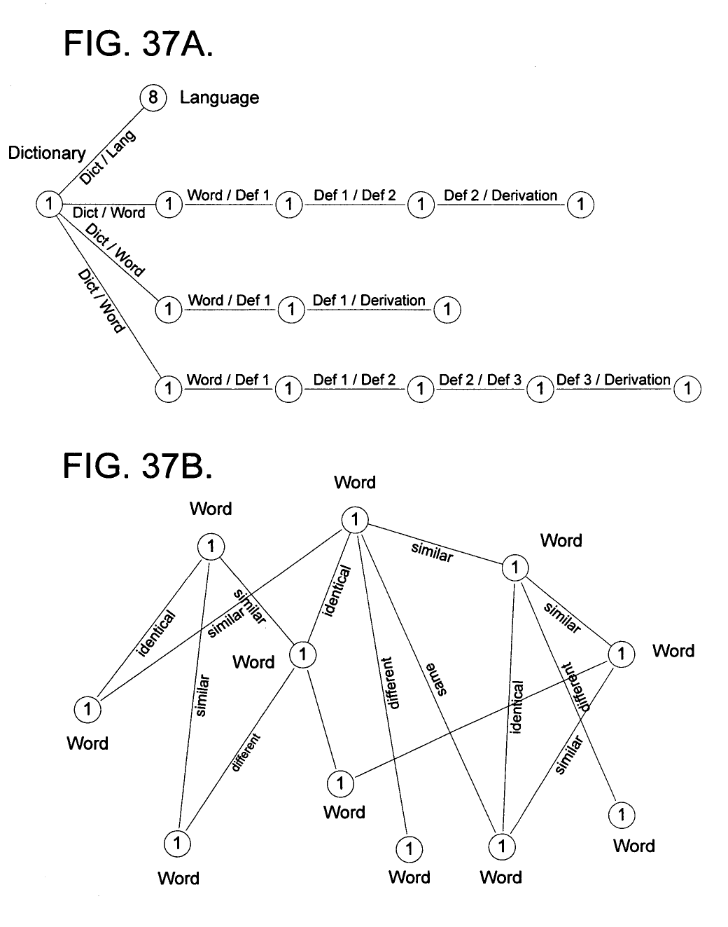

Using linked lists of words, one might build dictionaries for any particular language having each definition (including the derivation) as a link on the list. Dictionaries of any language can be constructed including all definitions of each word, as shown in FIG. 37A.

Although English (and other languages) is a highly homonymic language, each definition is technically a word in itself. When words of other languages are linked to words in any other language, we have produced a translation system. This database system natively supports the construction of this type of system. FIG. 37B represents just one way unique words may be associated (by their logics).

Other Uses

Search Engines

Current internet search engines in use today consider the “Key Word” search a standard. This is done by the extraction of all unique words from a body of text (in this case web pages on the internet) and these kept in a list referenced back to each of their sources. It's a simple technology.

However, it is not an intelligent one. For instance, an Orange (fruit) is different from Orange (color) from Orange (city) and Orange (county) and yet each of these would match for a search by the word “Orange” resulting in pages of unwanted matches one would have to sift through before arriving at what one was looking for.

The solution to that would have to include a more accurate classification of these words not just as the word but which word (by definition) we were applying. Since an Orange (fruit) is a Beingness, and Orange (color) a Modifier, and Orange (city or county) are Spaces, one has already eliminated a vast amount of unnecessary data towards the selection of the desired information. If would be far easier to look up a fruit when they are distinguished as they would be by the present invention.

6-Degrees of Separation

The theory of the 6-Degrees of Separation is a theory which hypothesizes that one is associated with anyone by an average distance of six people away. One, his friends, their friends, etc until one has encompassed everyone on Earth in just six connections.

This type of system can be created by linking Beingness to other beingnesses. While there may be more ways one might be associated, per this theory we're only interested in the connections of a being to another being.

Security

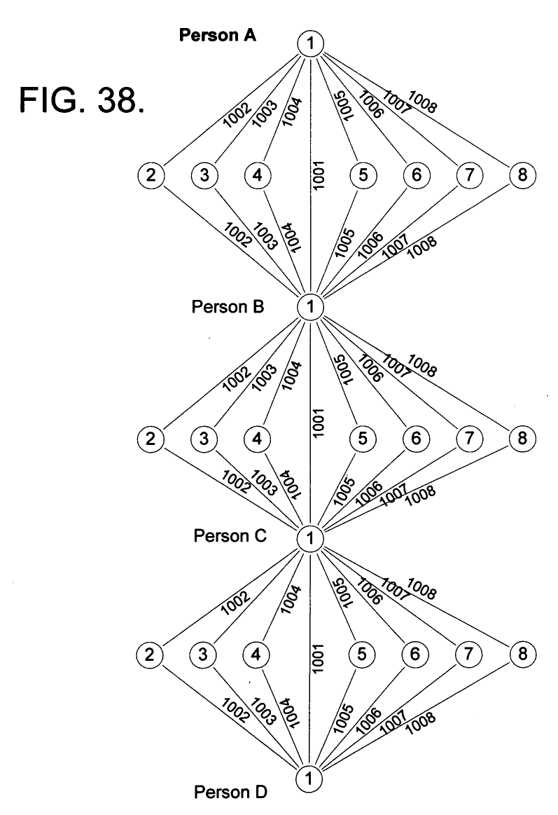

With reference to FIG. 38, in the world of security (such as for an airport screening system) one may be concerned with the association of a person walking through the line with anyone else with a known criminal record—more specifically a known terrorist. As criminals generally associate with other criminals, this type of search is very effective in weeding out suspicious characters to be investigated further.

Since anyone is linked with anyone else by 6-Degrees of Separation (6DOS) this doesn't mean anything. And if that's all the system reports then the person is probably okay. But if the relationship were one- or two-degrees of separation then we'd certainly be a lot more interested in this person and pull them out of the line to check more closely.

With this type of system, we could choose the Beingness association as in a true 6DOS system, but might find it more effective to count the number of links one has through any of the other elements. Two people living in the same town at the same time might not be suspicious. But if the were in several other places at the same time it would be. One might have links to known criminals using any of these Elements with the number of link connections being an indication of interest in this individual as a suspicious person.

Networking

The people who developed the 6DOS theory were interested in creating a computer or other network which could deliver anything from one location to another using only direction connections and without having to know the exact identity of the destination—something we can't yet do on the Internet. Their hope was to be able to deliver even an e-mail simply by knowing attributes of the recipient but not the recipient's email address.

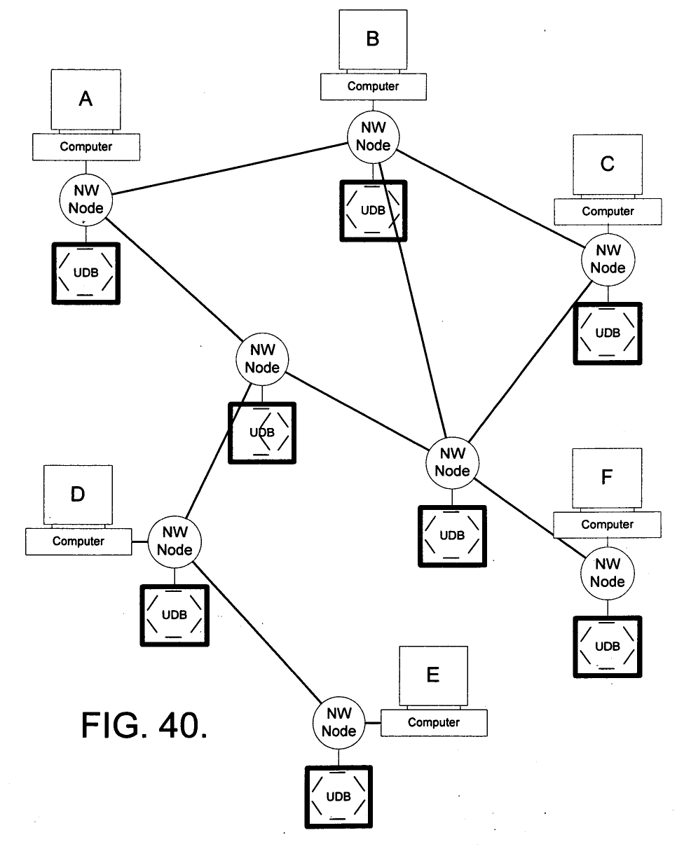

The reason earlier systems didn't work was that it would require each network node to be as intelligent as a person is in knowing and storing information by which to search. The most complex part of this whole system is having a standard data storage model which could be used for any purpose and contain any type of data in a useable form. This invention is currently the only known system capable of such a feat. FIG. 40. illustrates one such method of utilizing this model to make networks more intelligent as well as provide a standard interface for all queries (based upon the common elements defined in this invention).

This is because this invention's design supports any data type in an organized, fixed and finite number of elements. Using basic search techniques with this system it would be easy to find something. When one attaches an intelligent database system such as this invention to each network node and supply requests which can be defined by any Element, even a computer can process this logic and determine the number of matching attributes (in any element) and return the best match as the next destination for a data packet to be delivered.

Data Migration

Of course, since the invention is a superset of any other possible data system, every other system therefore is a subset of it. So Data Migration becomes as simple as marking each table field with one of the invention Element type while using the field name as the data type (or perhaps being more accurate and explicitly indicating it too). Doing this to all existing data tables an application could then be developed which reads all tables and generates the appropriate links as well as carries over the relationships from the original tables.

Data Storage & Retrieval

The database model of the present invention is preferably unchanging and the meat of the information processing is now the data stored. While it isn't possible to make an all-inclusive list of everything possible, this document intends to cover some of the key issues will be addressed.

In this model, data becomes the primary focus of the database rather than the database schema itself. What is stored is centrally important to being able to find what you're looking for. In prior systems, to look for something required an intimate knowledge of as many table formats as there were developers. However, with the BDH-SET model, the issues are vastly simplified. Searching the BDH-SET system would be incredibly simple as the data (Be, Do, Have, Space, Energy, Time, Quanta, or Modifier) and quite probably the data type too. An “Orange” as a fruit would already be differentiated from “Orange” the city or a county or even the color. This is the first level of identification which eliminates a lot of inapplicable data. Searches would thereby be more accurately targeting the relevant information with less wasted computing time. And it would be easy enough to add additional information to the query (such as a date range or location) to decrease further irrelevant results. Not just that, but your targeted subject would be found more readily in a search of the unique items of a Node because it is a list of non-repeated items. Even a reference to something could more accurately be targeted by data type or characteristic too. In other words, a Node can be searched by it's data type (here meaning the logical type and not the structural field type) to more accurately focus on the limited list of matching types more appropriate to one's search.

Despite what may potentially be a large number of links to any particular item, the fact that each node list is completely non-redundant would definitely decrease search effort even from a mechanical viewpoint.

Change Logging

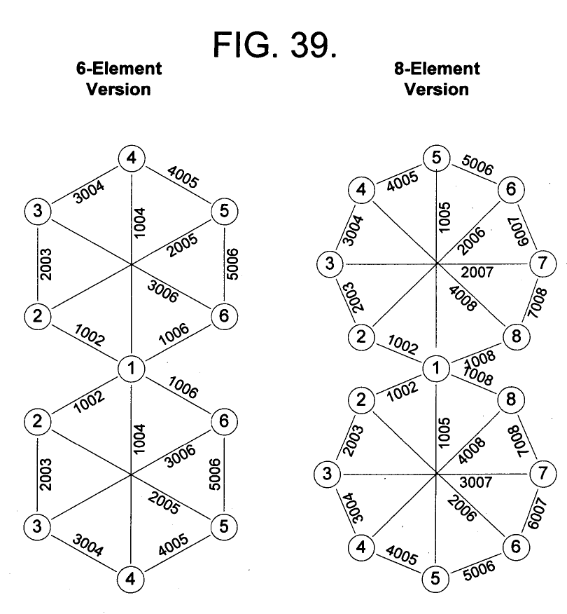

If one wanted to track the changes within any database, one would be looking for each of the values of this model. As represented in FIG. 39 with the lower half representing the database and the upper half representing the log itself, one is essentially taking a picture of what changed at any particular time.

A person is always part of the data being changed and that's why the halves are linked on that element. To exemplify this concept one might consider an Intelligence Agency security system and notice that anyone changing anything is also someone who should be part of a search.

The action taken to the data (insert, update, delete) is a Doingness. What was changed is a Havingness. When it was changed is Time. The location of the computer terminal is a Space. The authorization (force) of the user is Energy. And one might consider other factors which can be stored as Quanta or Modifiers. Ties these all together and one has a report on something which has changed. This type of log information is typical, however the method of storing it is unique.

HW & Chip Integration

As the database design of the present invention is preferably's a standard and unchanging system and model, it is possible to incorporate this technology in hardware form. It could be imbedded into semi-conductor and other electronics formats as a means of reproducing mass quantities of embedded databases. This type of standard, unchanging technology which is flexible enough to support any known data requirements is ideal for hardware embedding.

Although several embodiments have been described in detail for purposes of illustration, various modifications may be made to each without departing from the scope and spirit of the invention. Accordingly, the invention is not to be limited, except as by the appended claims.

What is claimed is:

1. A method for creating a database system, comprising the steps of:
establishing a plurality of data-storing nodes, each node representing a different specific characteristic containing user-defined data, wherein the plurality of nodes represent common denominator characteristics of all data to be added to the database system;
creating a many to many relationship between the nodes by connecting each node to every other node, and to itself using link nodes having assigned identifications and data relating to the two nodes the link node connects;
classifying datum according to the specific node characteristics and user-assigned characteristics of each datum; and
storing each datum in the node representing the corresponding characteristic.

2. The method of claim 1, wherein the plurality of nodes comprise at least six nodes.

3. The method of claim 2, wherein the six nodes are assigned user-defined data for the specific characteristics of: be, do, have, space, energy, and time.

4. The method of claim 1, wherein the plurality of nodes comprise eight nodes.

5. The method of claim 4, wherein the eight nodes are assigned user-defined data with the specific characteristics of: be, do, have, space, energy, time, quanta, and modifier.

6. The method of claim 1, further including the step of connecting a node and a link node with a link link node.

7. The method of claim 6, wherein the link link node is assigned identifications and data relating to the node and link node which it connects.

8. The method of claim 1, including the step of defining a relationship between data of two nodes.

9. The method of claim 8, wherein the relationships are defined as similarities, differences, and identities.

10. A method for creating a database system, comprising the steps of:
establishing at least six data-storing nodes, each node representing a different specific characteristic containing user-defined data, wherein the plurality of nodes represent common denominator characteristics of all data to be added to the database system;
creating a many to many relationship between the nodes by connecting each node to every other node, and to itself using link nodes having assigned identifications and data relating to the two nodes the link node connects, and connecting nodes to link nodes using link link nodes having assigned identifications and data relating to the node and link nodes the link link node connects;
defining a relationship between data of two nodes or link nodes;
classifying datum according to user-assigned characteristic of each datum; and
storing each datum in the node representing the corresponding characteristic.

11. The method of claim 10, wherein the six nodes are assigned user-defined data for the specific characteristics of: be, do, have, space, energy, and time.

12. The method of claim 10, wherein the at least six nodes consists essentially of eight nodes.

13. The method of claim 12, wherein the eight nodes are assigned user-defined data for the specific characteristics of: be, do, have, space, energy, time, quanta, and modifier, with user-defined datum for each.

14. The method of claim 10, wherein the relationships are defined as similarities, differences, and identities.

15. A computer system having a database, comprising:
a main memory;
a programmed processor; and
a non-volatile storage medium having at least six data-storing nodes, each node representing a different specific characteristic containing user-defined data for each, wherein the plurality of nodes represent common denominator characteristics of all data to be added to the database;
wherein the nodes are connecting each node to every other node, and to itself using link nodes having assigned identifications and data relating to the two nodes the link node connects to create a many to many relationship between the nodes;
wherein data is stored in each node according to a user-assigned characteristic of each datum corresponding to the characteristic of the node; and
wherein the programmed processor is used to define a relationship between data contained in the connected nodes.

16. The method of claim 15, wherein the at least six nodes are assigned user-defined data for the specific characteristics of: be, do, have, space, energy, and time.

17. The method of claim 15, wherein the plurality of nodes consist essentially of eight nodes assigned user-defined data for the specific characteristics of: be, do, have, space, energy, time, quanta, and modifier.

18. The method of claim 15, wherein the nodes and link nodes are connected with a link link node, wherein the link link node is assigned identifications and data relating to the node and link node which it connects.

19. The method of claim 15, wherein the relationships are defined as similarities, differences, and identities.
